(19) United States
(12) Patent Application Publication
(10) Pub. No.: US 2015/0357064 A1
(43) Pub. Date: Dec. 10, 2015

(54) WATER INTAKE INSTALLATION FOR COOLING A NUCLEAR POWER PLANT, AND NUCLEAR POWER PLANT COMPRISING SUCH AN INSTALLATION

(71) Applicant: ELECTRICITE DE FRANCE, Paris (FR)

(72) Inventor: Christophe Legendre, Virandeville (FR)

(21) Appl. No.: 14/763,059

(22) PCT Filed: Jan. 22, 2014
(86) PCT No.: PCT/FR2014/050123

§ 371 Date: Jul. 23, 2015

(30) Foreign Application Priority Data
Jan. 25, 2013 (FR) 1350674

(51) Int. Cl. G21D 3/04; G21D 1/00

(52) U.S. Cl. CPC G21D 3/04; G21D 1/00

(57) ABSTRACT

Water intake installation comprising a suction basin from which a pumping station supplies water to a cooling circuit, and a suction tunnel that supplies water to the suction basin so as to maintain a sufficient water level. The water intake installation furthermore comprises a system for supplying additional water, able to supply water to the suction basin from an emergency water reserve. The system for supplying additional water comprises a water duct connecting the suction basin to said emergency water reserve and an obstructing device able to open the water duct if the water level in the suction basin drops in a way defined beforehand as being abnormal. Nuclear power plant comprising such a water intake installation, especially suitable for establishment on a coastline vulnerable to tsunami flooding.

The invention relates to a water intake installation for at least one heat exchanger-based cooling circuit, comprising a suction basin supplied with water and from which at least one pumping station of the plant draws water in order to circulate it within one said cooling circuit, and further comprising at least one suction tunnel connected to at least one main water intake submerged in a body of water such as a sea, lake, or river, said suction tunnel supplying the suction basin with water so as to maintain a water level in the suction basin that is sufficient for the operation of the pumping station.

The heat exchanger-based cooling circuit is typically designed to cool the steam exiting a turbine-generator in a secondary circuit of a reactor of the nuclear plant, in order to condense this steam so that water returned to the liquid state is fed back to the steam generators of the secondary circuit. The steam generators draw heat from a pressurized primary circuit to cool the reactor, by heat exchange between the primary circuit and the secondary circuit. The primary and secondary circuits are closed systems fluid-wise, while the heat exchanger-based cooling circuit is open and completely isolated from the secondary circuit which in turn is completely isolated from the primary circuit. The water exiting a heat exchanger is therefore not radioactive, and can be drained away for example to be returned to the body of water supplying the circuit.

A water intake installation as defined above is known, particularly the Seabrook nuclear power plant, constructed near the coastline in southern New Hampshire (USA) and commissioned in 1990. The installation comprises a single suction tunnel several kilometers long, connected to three vertical suction shafts. Each suction shaft opens just above the seabed about fifteen meters below the average water level, and comprises an upper portion forming one of said submerged water intakes.

Also known, from Japanese patent application no. JP60111089A published on 17 Jun. 1985, is a water intake installation comprising a suction basin supplied with water by an underground suction tunnel, the tunnel being connected to a water intake submerged at a relatively shallow depth in the sea. The water intake could be left exposed before a tsunami wave.

These water intake installations are not designed to handle the admittedly unlikely situation of a critical collapse in the suction tunnel, which would result in almost complete obstruction of the tunnel, the consequence being the almost complete interruption in the supply of water to the suction basin and the risk of insufficient water supplied to the backup pumps of the plant's pumping station. The backup pumps are typically auxiliary pumps to supplement the pumps of a pumping station that are used during electricity production (“production pumps”), and are provided to supply a reduced flow to the heat-exchanger based cooling circuit when the production pumps are shut down. These backup pumps are intended for cooling the nuclear reactor or reactors when they are shut down for a long or extended period.

Even if there are two suction tunnels, one cannot ignore the possibility of a critical collapse in both suction tunnels almost completely cutting off the supply of water to the suction basin and therefore to the pumping station, particularly in areas of relatively high seismic risk. Furthermore, supplying water to the suction basin by a tunnel connected to a water intake submerged in the sea can have the advantage of significantly lowering the maximum temperature of the water in the suction basin compared to the maximum temperature of the water at the surface of the sea, this lower temperature being related primarily to the depth at which the water intake is placed below the mean sea level. The addition of a second suction tunnel to supplement a first suction tunnel, in order to limit the risk of an interruption in the supply of water to the suction basin in case of a critical collapse in the first tunnel, involves placing the new water intakes at least at substantially the same depth as the first water intakes, to avoid significantly heating the water in the suction basin.

Warming the water in the suction basin does indeed result in a decrease in the efficiency η of a secondary circuit of the plant. The efficiency depends on the temperature Tf of the cold source, meaning the temperature of the water at the inlet to the heat exchangers, and is defined as follows:

η=(Tc−Tf)/Tc

Tc being the temperature of the heat source, meaning the temperature of the water exiting the heat exchangers. The efficiency η therefore increases as the temperature Tf of the cold source decreases.

Depending on the underwater topology, the necessary length of a suction tunnel generally increases with the depth at which the water intakes are arranged. In addition, besides the cost of constructing an additional tunnel, the risk of a critical collapse in the tunnel also generally increases with the tunnel length, especially in areas at risk for major seismic events. The solution of an additional suction tunnel to provide a more secure supply of water to the suction basin is therefore not entirely satisfactory, either because of the lower efficiency of the plant's secondary circuits when the additional water intakes are not as deep, or in terms of cost and/or safety when the additional water intakes are deeper.

The present invention aims to provide a water intake installation in which, when there is a critical collapse in the suction tunnel or tunnels supplying the suction basin, water continues to be supplied to the suction basin for at least the backup pumps of the plant's pumping station; this installation does not affect the efficiency of a secondary circuit of the plant during normal operation of the plant, meaning when water is supplied in the normal manner to the suction basin by the suction tunnel or tunnels.

To this end, the invention relates to a water intake installation as defined in the preamble above, characterized in that it further comprises a system for supplying additional water distinct from said at least one suction tunnel and capable of supplying water to the suction basin from at least one emergency water reserve, said system for supplying additional water comprising at least one water duct connecting the suction basin to said emergency water reserve and an obstructing device closing off said water duct, the obstructing device being able to open said water duct at least partially if the water level in the suction basin drops in a manner defined beforehand as abnormal, so that the suction basin is supplied with water by said system for supplying additional water if the water supplied by said at least one suction tunnel becomes insufficient.

With these arrangements, the water of the suction basin generally does not mix with the water from an emergency water reserve during normal plant operation, and therefore the efficiency of a secondary circuit of the plant is not impacted by the presence of an emergency water reserve. The use of an emergency water reserve is only triggered if the water level in the suction basin drops in a manner defined beforehand as abnormal. A drop in water level defined beforehand as abnormal generally corresponds to a critical collapse in one or more suction tunnels, resulting in a lasting interruption or at least a major decrease in the supply of water to the suction basin. Such a drop in water level may also correspond to an exceptional drop in the body of water for a relatively short period, as may occur for example along the coastline in areas prone to tsunamis. The invention therefore also can be applied to water intake installations for nuclear power plants on the coastline where on rare occasions the sea may drop below the level of the lowest tide, as is sometimes the case before the first wave of a tsunami.

According to an advantageous embodiment of a water intake installation according to the invention, said body of water constitutes one said emergency water reserve. In this manner, the supplying of water to the suction basin by said system for supplying additional water can continue for an unlimited period and with no need for pumping means to maintain the water level in the emergency water reserve.

In other preferred embodiments of a water intake installation according to the invention, use is made of one or more of the following arrangements:

said body of water is a sea, and said system for supplying additional water is arranged between the suction basin and a portion of a channel which communicates with the sea;

said system for supplying additional water comprises a backup tunnel connected to at least one backup water intake submerged in said body of water, said backup water intake being placed at a height at least ten meters above one said main water intake;

one said at least one emergency water reserve comprises a reserve basin containing a volume of water which remains substantially unchanged when water is being supplied normally to the suction basin by said at least one suction tunnel;

said at least one main water intake is placed at a certain depth relative to a mean reference level of said body of water, said depth being determined such that the water flowing into the suction basin has, during at least one period of the year, a maximum temperature at least 4° C. less than the maximum temperature of the water at the surface of said body of water;

said obstructing device comprises an obstructing member able to pivot about a pivot shaft in order to open said water duct;

said obstructing device is adapted so that the pivoting of said obstructing member occurs autonomously according to a drop in the water level in the suction basin;

the pivoting of said obstructing member is actuated by a trigger device connected to a control system able to generate a trigger command for the trigger device, the control system being associated with an analysis system receiving data provided by a device for measuring the water level in the suction basin, said analysis system being able to determine whether the water level in the suction basin is dropping in a manner defined beforehand as abnormal;

said trigger device is adapted to allow the pivoting of said obstructing member to be performed autonomously by said obstructing device if the trigger device does not perform its function:

said obstructing member pivots to open said water duct when a height difference between the water level in the emergency water reserve and the water level in the suction basin exceeds a predetermined threshold;

said obstructing device comprises a counterweight means arranged on a side opposite the obstructing member relative to said pivot shaft, said counterweight means comprising a main counterweight member located at a fixed distance from said pivot shaft, and said main counterweight member weighing between 80% and 200% of the weight of said obstructing member;

said obstructing device comprises a float device arranged so that it is fully submerged in water when water is being supplied normally by said at least one suction tunnel and so that it is at least partially exposed if the water level in the suction basin falls below a predetermined level of lowest tide to reach a predetermined trigger level, said float device being adapted to cause said obstructing member to pivot when said trigger level is reached.

The invention also relates to a nuclear power plant comprising a water intake installation according to the invention, wherein the suction basin is covered by a device forming a substantially watertight cover, and at least one calibrated opening is made in the cover device or nearby to allow a limited flow of water to outside the suction basin if the suction basin overflows due to an unusual rise in said body of water, the nuclear power plant further comprising at least one discharge shaft feeding water to an outflow tunnel, said discharge shaft also being provided with a cover device having at least one calibrated opening to allow a limited flow of water to the outside in case of overflow of the discharge shaft.

According to an advantageous embodiment of such a nuclear power plant, one said emergency water reserve comprises a reserve basin having its top open to the outside and containing a volume of water that remains substantially unchanged when water is being supplied normally to the suction basin by said at least one suction tunnel, and said at least one calibrated opening leads to said reserve basin to allow collecting said limited flow of water therein.

Other features and advantages of the invention will be apparent from the following description of some non-limiting exemplary embodiments, with reference to the figures in which:

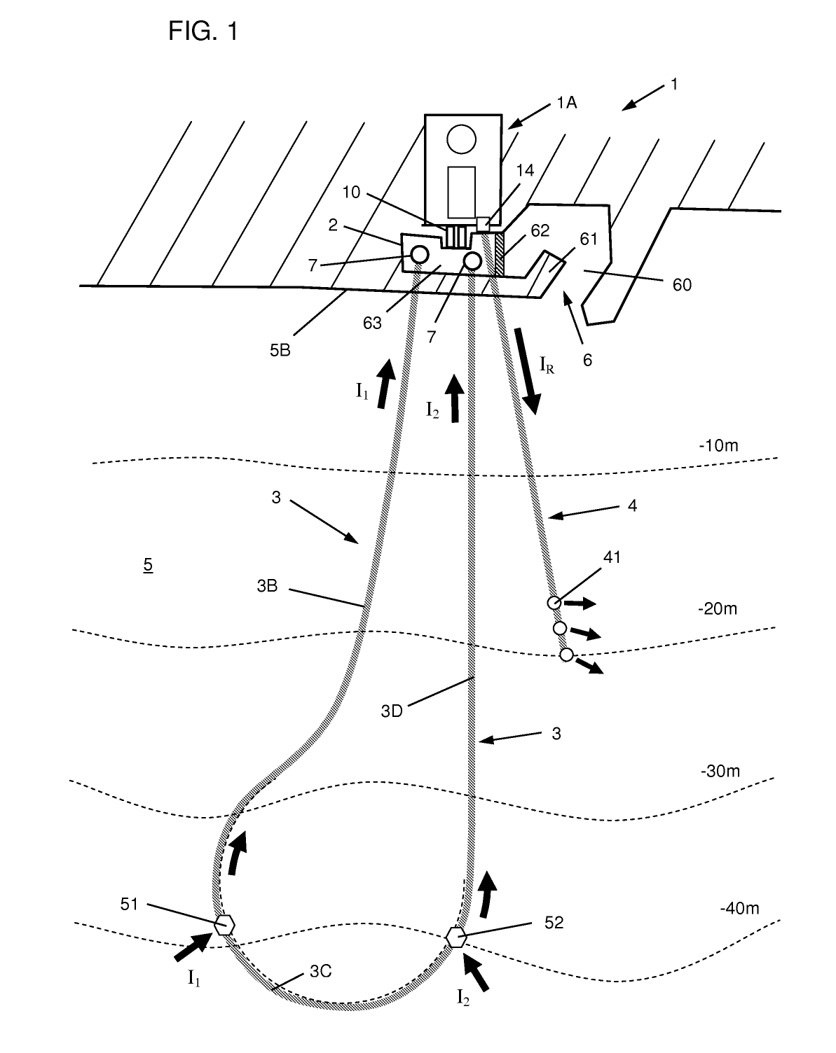

FIG. 1 schematically represents a top view of a nuclear power plant near the coastline, comprising a water intake installation able to be modified to equip it with a system for supplying additional water.

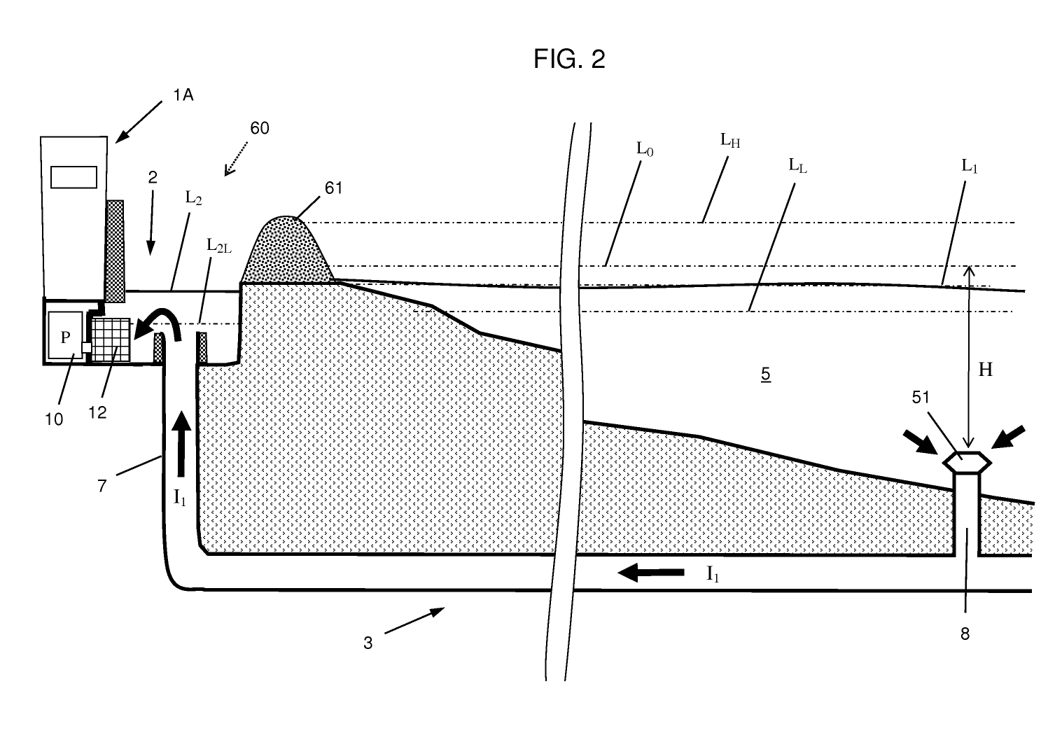

FIG. 2 schematically represents a partial side view of the water intake installation represented in FIG. 1, as well as the different tide levels to be taken into account in the design.

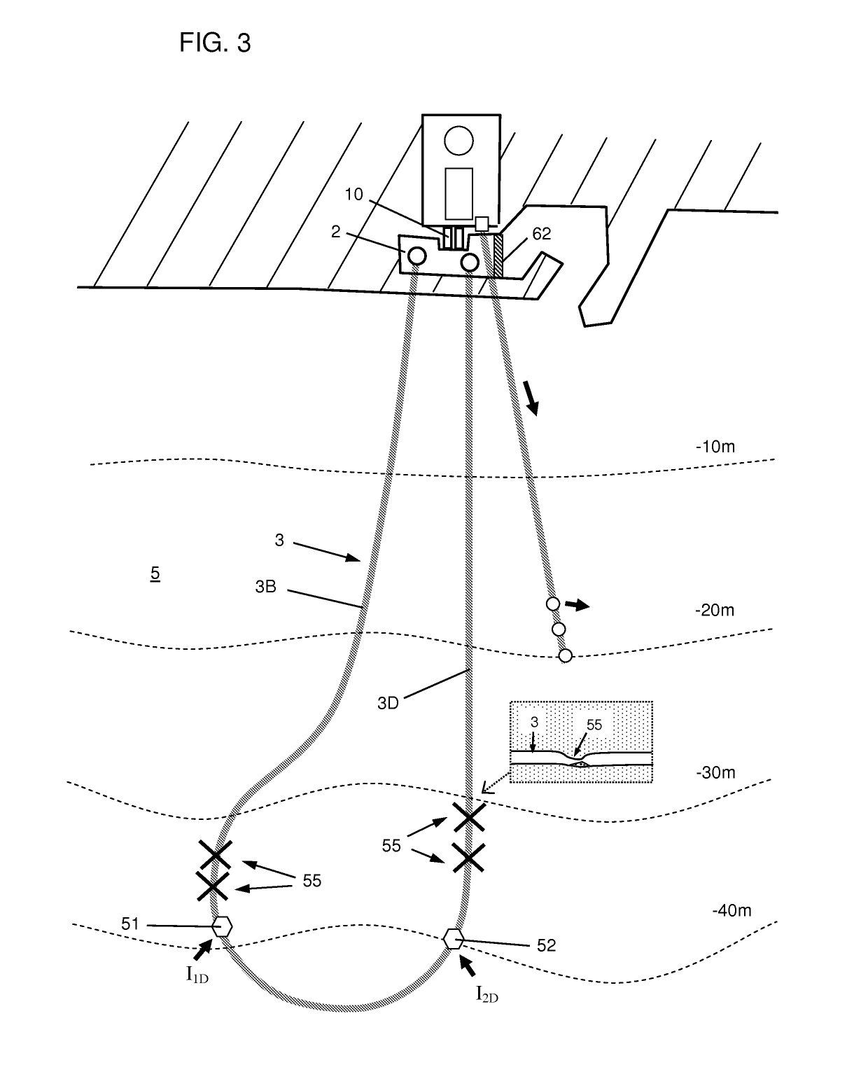

FIG. 3 schematically represents a top view of the nuclear power plant of FIG. 1, in a situation with highly degraded operation of the suction tunnel after a collapse; this situation does not allow the plant to continue operating normally.

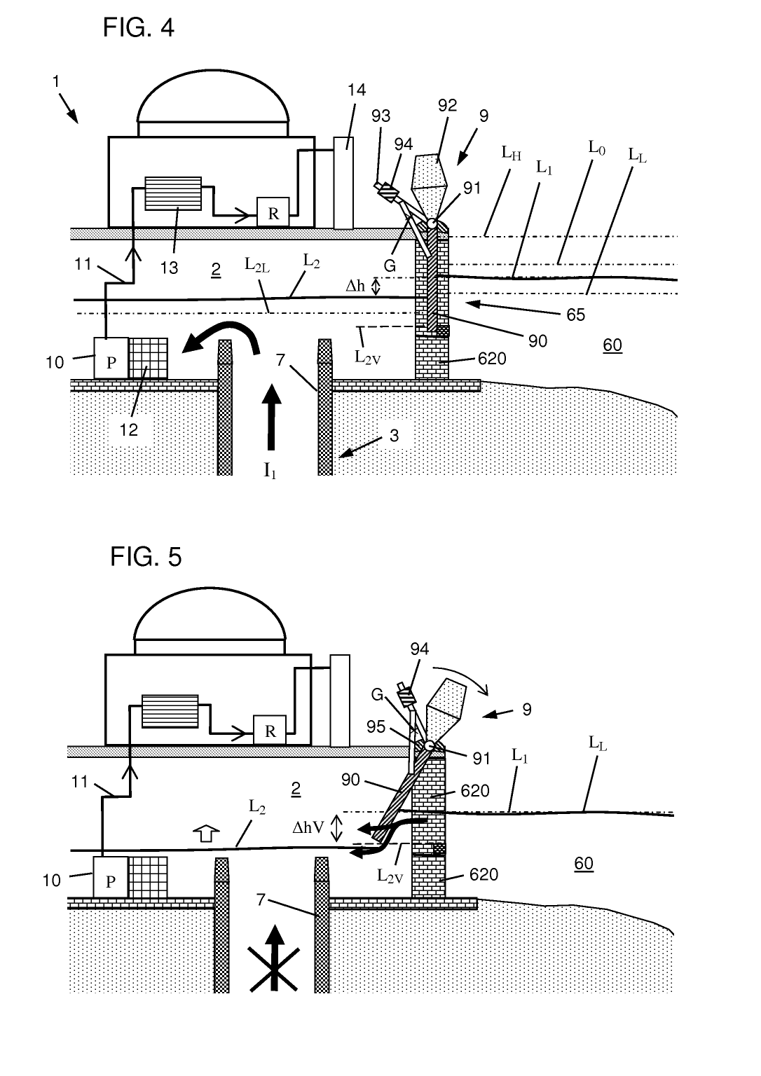

FIG. 4 schematically represents a partial side view of modifications made to the water intake installation of FIG. 1 in order to implement a system for supplying additional water according to the invention, with the obstructing device of the system represented in a position where it closes off the water duct.

FIG. 5 represents the system for supplying additional water of FIG. 4, with the obstructing device in a position that opens the water duct, placing the suction basin in communication with a channel.

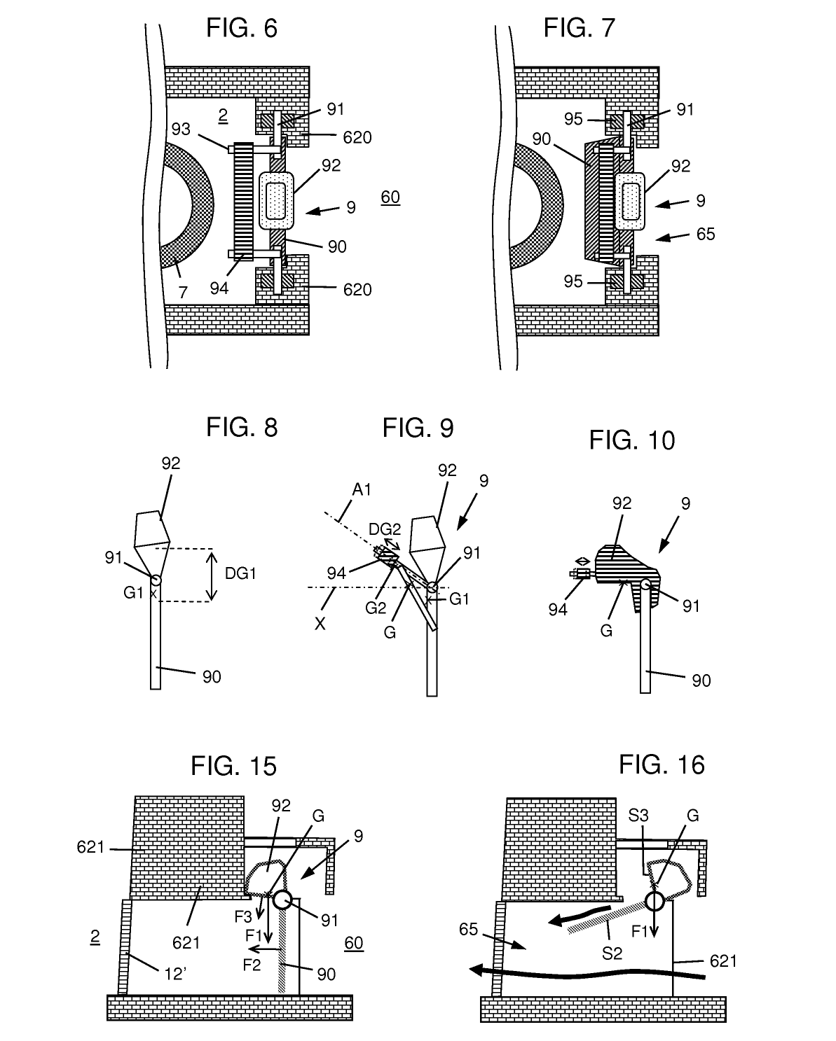

FIG. 6 schematically represents a partial top view of the system for supplying additional water of FIG. 4.

FIG. 7 schematically represents a partial top view of the system for supplying additional water of FIG. 4, with the obstructing device in the open position of FIG. 5.

FIG. 8 schematically represents a partial side view of a portion of the obstructing device of FIG. 4.

FIG. 9 schematically represents a partial side view of the obstructing device of FIG. 8 plus a counterweight adjustment means.

FIG. 10 schematically represents a partial side view of an obstructing device similar to the one of FIG. 9.

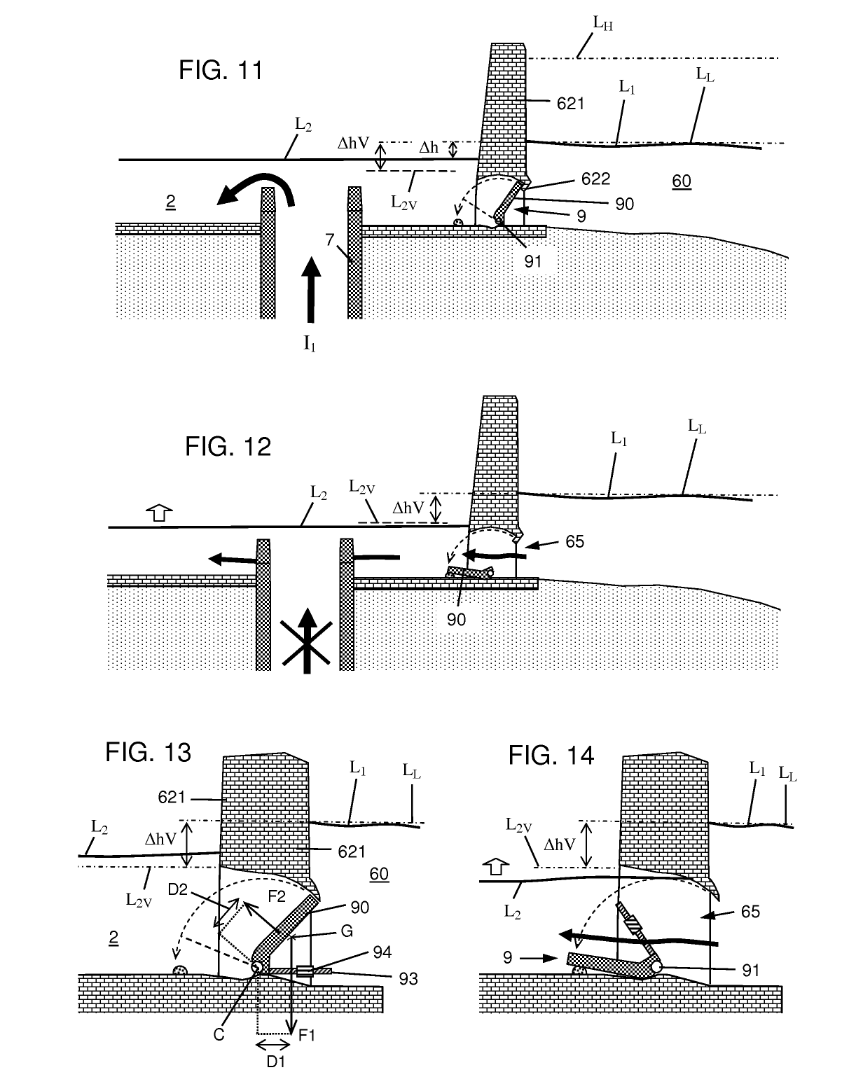

FIG. 11 schematically represents a partial side view of another embodiment of a system for supplying additional water of the invention, which can be used as an alternative to the system for supplying additional water of FIG. 4.

FIG. 12 represents the system for supplying additional water of FIG. 11 with the obstructing device in a position that fully opens the water duct.

FIG. 13 schematically represents a partial side view of a variant of the system for supplying additional water of FIG. 11, with the obstructing device in a position that closes off the water duct.

FIG. 14 schematically represents the system for supplying additional water of FIG. 13, with the obstructing device in a position that fully opens the water duct.

FIG. 15 schematically represents a partial side view of another variant of a system for supplying additional water similar to that of FIG. 11, with an obstructing device according to another embodiment.

FIG. 16 represents the system for supplying additional water of FIG. 15, with the obstructing device in a position that fully opens the water duct.

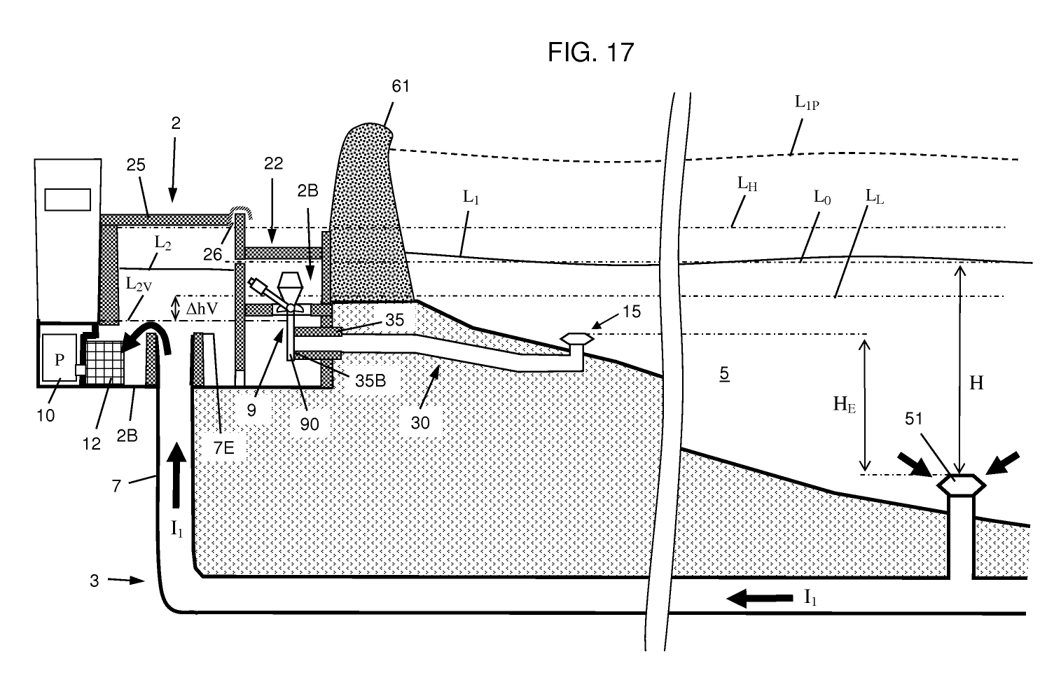

FIG. 17 schematically represents a partial side view of another embodiment of a water intake installation of the invention for a nuclear power plant that could experience a tidal wave, the obstructing device of the water supply system being represented in a position that closes off the water duct.

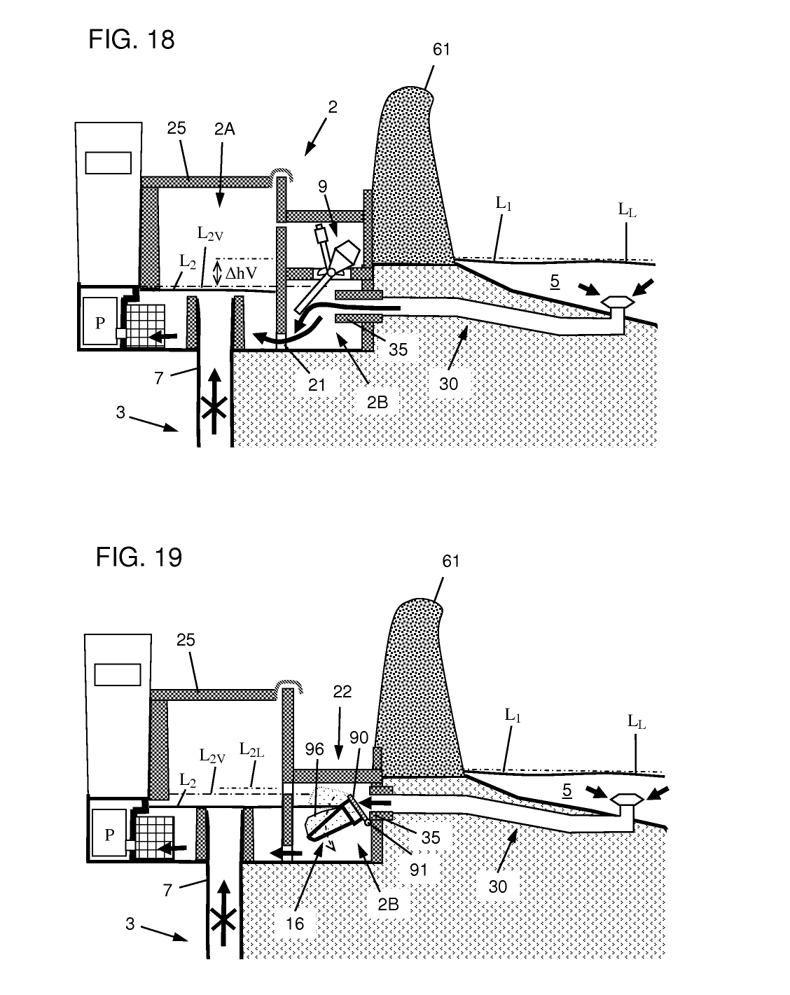

FIG. 18 represents the system for supplying additional water of FIG. 17, the obstructing device being in a position that opens the water duct so that the suction basin communicates with the sea via a backup tunnel.

FIG. 19 schematically represents a partial side view of the system for supplying additional water of FIG. 17, equipped with an obstructing device according to another embodiment.

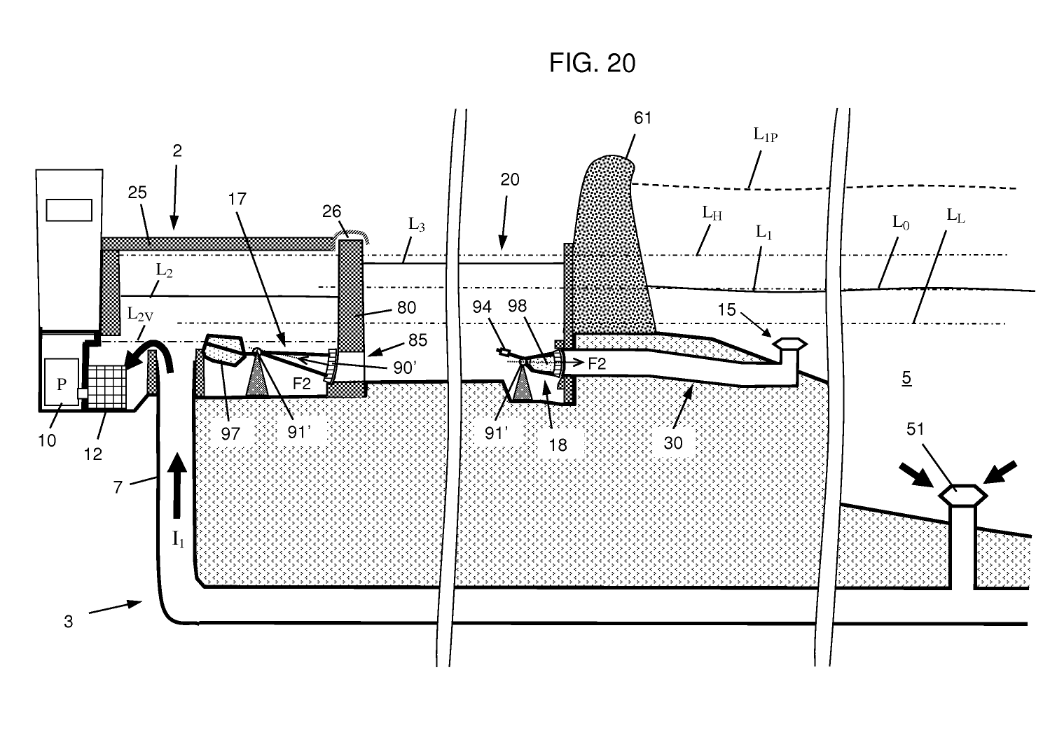

FIG. 20 schematically represents a partial side view of another embodiment of a water intake installation of the invention, for a nuclear power plant by the coastline that could experience a tidal wave, with a first emergency water reserve comprising a reserve basin particularly intended for handling a tsunami situation.

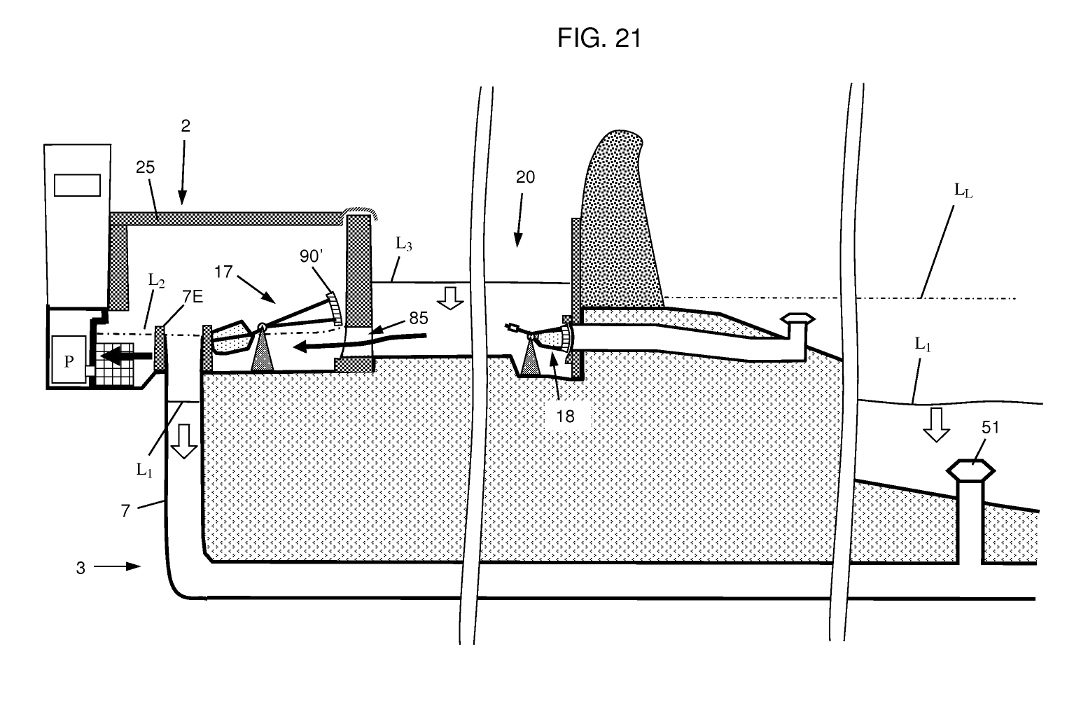

FIG. 21 represents the water intake installation of FIG. 20 in a situation where the sea bordering the plant drops below the level of the lowest tide prior to the first wave of a tsunami, the reserve basin allowing the supply of water to the production pumps to continue.

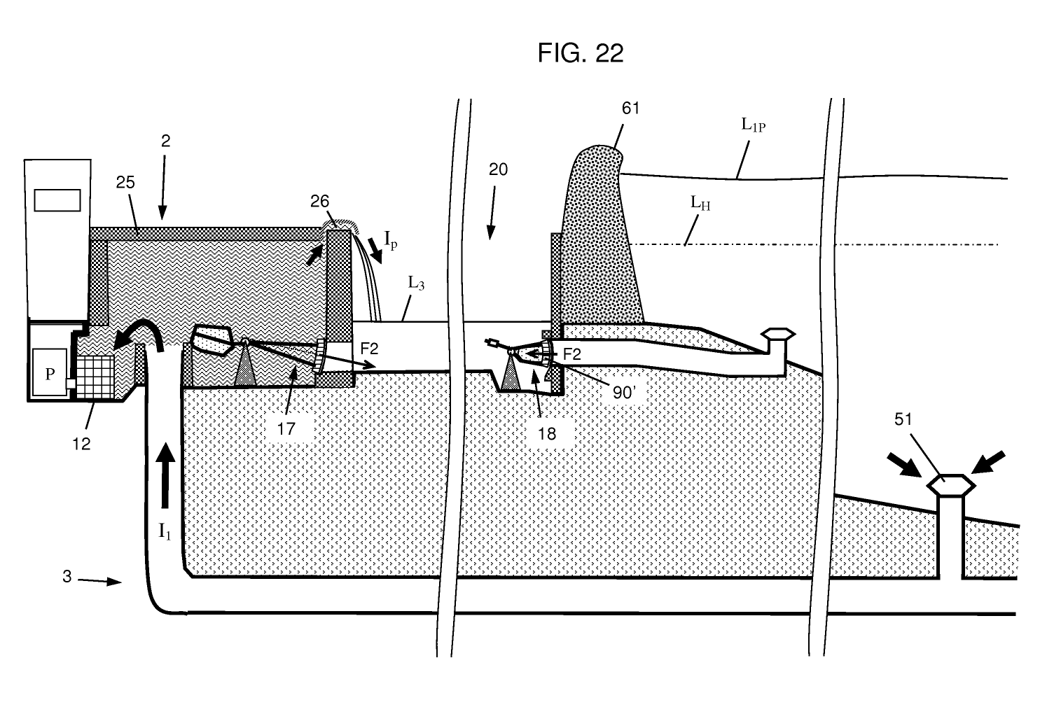

FIG. 22 represents the water intake installation of FIG. 20 in a situation where the level of the sea bordering the plant reaches its peak during a tsunami.

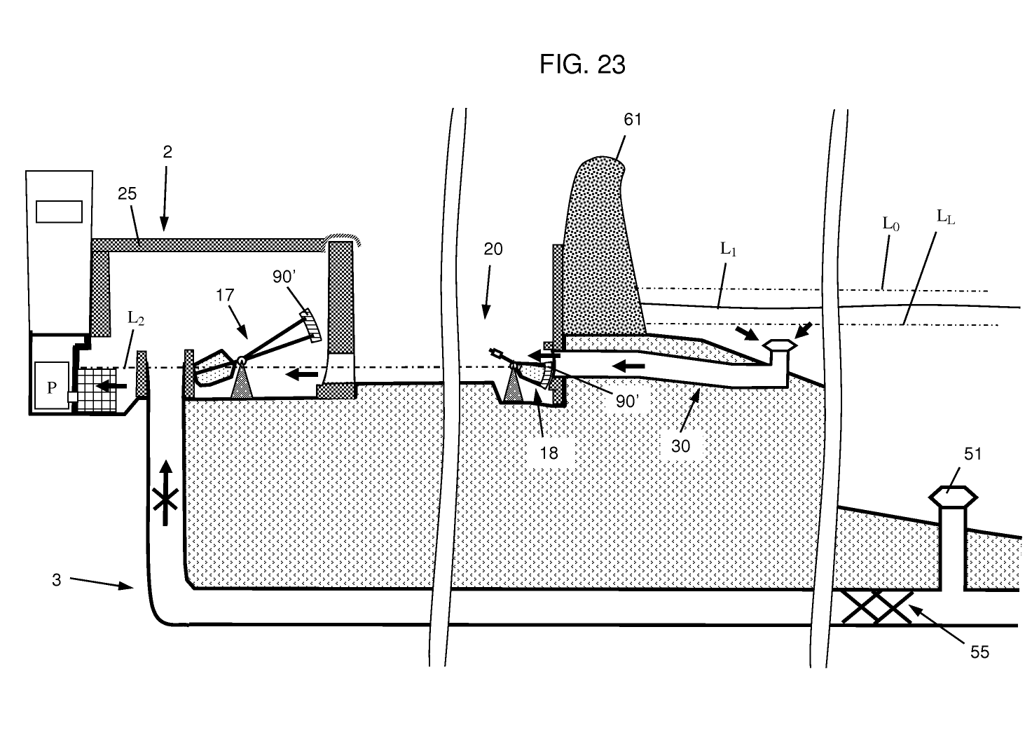

FIG. 23 represents the water intake installation of FIG. 20 in a situation where the supply of water through the suction tunnel to the suction basin is interrupted due to a collapse, the suction basin being supplied with water indirectly by a backup tunnel in order to maintain operation of the backup pumps.

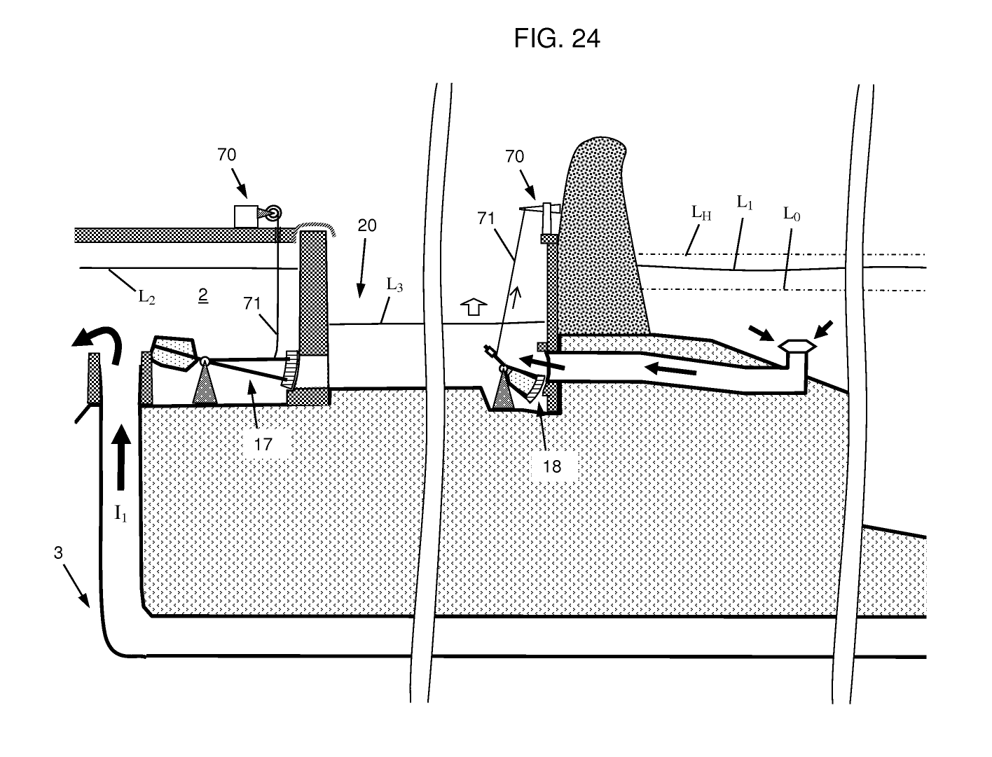

FIG. 24 schematically represents a portion of the water intake installation of FIG. 20, in which trigger devices are installed to control the opening of the obstructing devices sealing off the system for supplying additional water, one of the trigger devices being represented as actuated to allow the reserve basin to be filled.

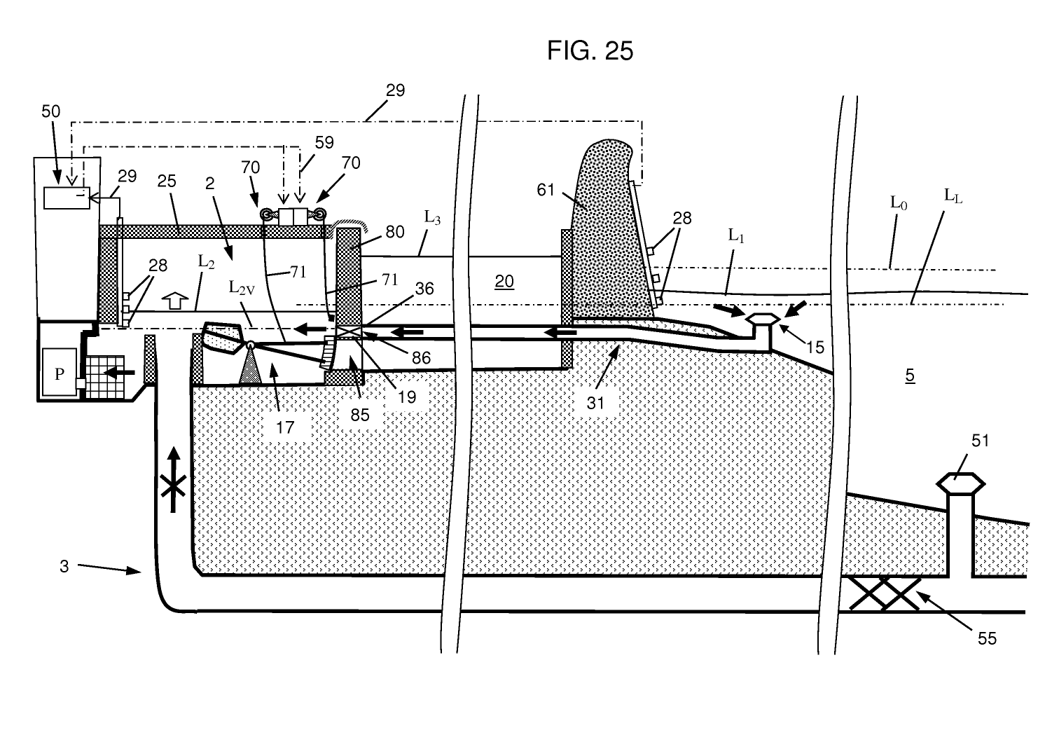

FIG. 25 schematically represents another embodiment of the water intake installation of FIG. 23, in the same situation where the supply of water through the suction tunnel to the suction basin has been interrupted, the suction basin being supplied with water directly by a backup tunnel.

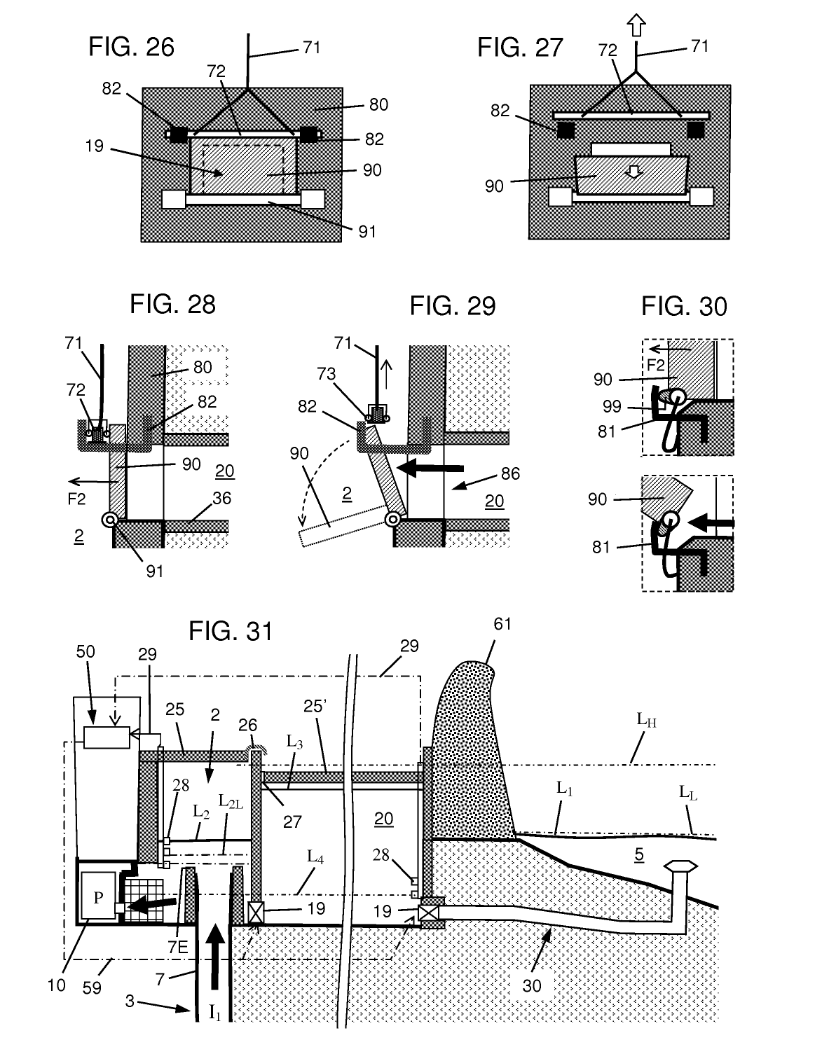

FIG. 26 schematically represents a front view of one embodiment of an obstructing device with exclusively controlled opening, usable in a water supply system of the water intake installation of FIG. 25, the obstructing device being shown in a position where it closes off the water duct.

FIG. 27 represents the obstructing device of FIG. 26 in an intermediate position of unobstructing the water duct immediately after it is triggered to open.

FIG. 28 schematically represents a partial side view of the obstructing device of FIG. 26.

FIG. 29 represents the obstructing device of FIG. 28 in an intermediate position of unobstructing the water duct.

FIG. 30 schematically represents a partial side view of a modified portion of the obstructing device of FIG. 26, in a position of closing off the water duct as well as in an intermediate position of unobstructing the water duct.

FIG. 31 schematically and partially represents another embodiment of a water intake installation similar to that of FIG. 20, where both the reserve basin and the suction basin are covered by a cover device.

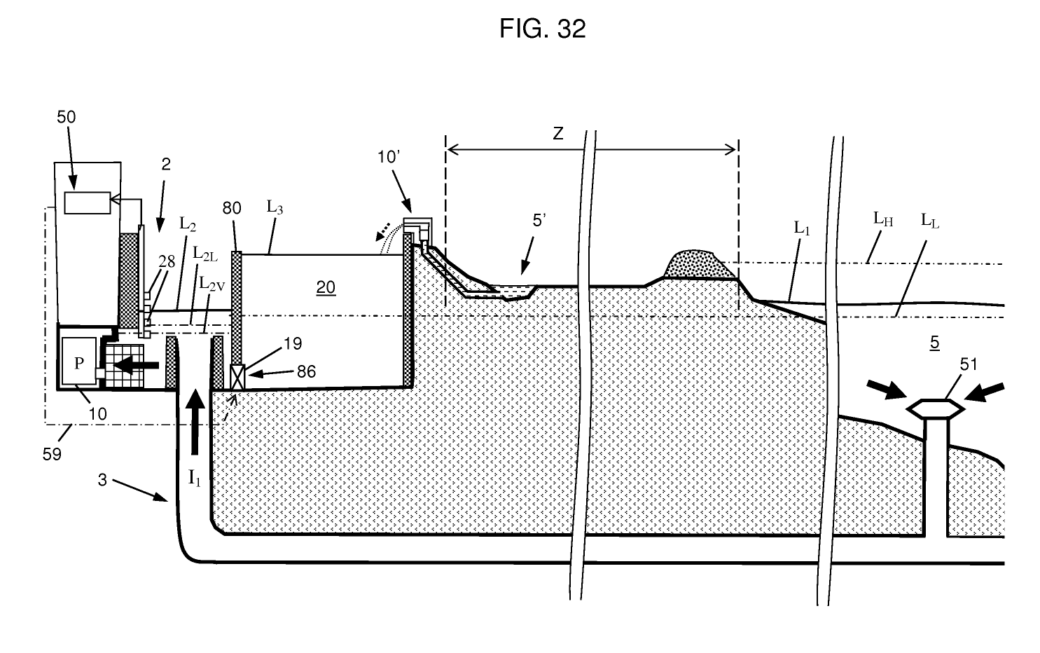

FIG. 32 schematically represents a partial side view of another embodiment of a water intake installation of the invention for a nuclear power plant separated from the water's edge by a strip of land not suitable for construction, an emergency water reserve comprising a reserve basin which can be supplied water from an auxiliary water source such as a river.

FIG. 1, FIG. 2, and FIG. 3 represent the same water intake installation and are discussed together in the following. The water intake installation is installed at the site of a nuclear power plant 1 on the coastline, and comprises a suction basin 2 located in a bottom portion 63 of a channel 6, as well as an underground suction tunnel 3 which supplies the suction basin with water. A plant pumping station 10 pumps water into the suction basin 2 for use in at least one heat exchanger-based cooling circuit. The underground tunnel 3 is in communication with the suction basin 2 by means of two shafts each formed by a generally vertical passage 7 which leads to the bottom 2B of the basin, as represented in FIG. 2.

The underground suction tunnel 3 is visible in FIGS. 1 and 3 for explanatory purposes, but it is understood that this tunnel is buried below the seabed and is therefore not visible from the sea. The tunnel 3 extends to a certain distance from the shoreline, passing below the bed to reach a depth below sea level (MSL in France) that is defined beforehand based on a maximum temperature that the water in the suction basin is not to exceed. In the embodiment represented in FIG. 1, the suction tunnel 3 lies under the seabed at depths of about 40 meters below mean sea level, and is connected to two water intakes 51 and 52 spaced apart from each other.

Each water intake 51 and 52 sits several meters above the seabed at a depth H below mean sea level L₀, and is located at an upper end of a substantially vertical suction shaft 8 connected to the suction tunnel as represented in FIG. 2. The water gains very little heat in an underground suction tunnel, and therefore the water arriving at the suction basin is substantially the same temperature as the water collected at a water intake 51 or 52. Preferably, the depth H is determined so that the water reaching the suction basin 2 has a maximum temperature during at least a period of the year that is at least 4° C. lower than the maximum surface temperature of the water constituting the body of water 5.

In the example represented in FIG. 1, the suction tunnel 3 forms a loop having a curved section 3C forming at least a half-circle, and has two ends which each communicate with the suction basin 2 by means of a generally vertical passage 7. The water intakes 51 and 52 allow the tunnel to pull water in respective streams flowing at rates I₁ and I₂ that are a function of the pumping rate of the pumping station 10. If a reactor unit 1A at full power requires about 70 m3 per second of water during normal operation for example, the flow rate of each stream I₁ or I₂ is about 35 m3 per second of water. The inside diameter of the tunnel 3, as well as the inside diameter of a passage 7 and of a suction shaft 8, is chosen to be about 5 meters for example, which ensures a flow rate of 70 m3 per second of water in one arm 3B or 3D of the tunnel without substantial head loss in an unaffected arm if the other arm is blocked by a collapse.

In a water intake installation according to the invention, it is not necessary for the suction tunnel 3 to form a loop or for only one suction tunnel 3 to supply a suction basin 2 of the plant. Any other form of suction tunnel is possible, and a suction basin 2 can be supplied with water by two or even three separate suction tunnels. In particular, if one suction basin is allocated to pumping stations for multiple reactors of a plant, for safety reasons or in order to maintain the necessary flow rate it may be decided to have the suction basin supplied by two looped suction tunnels 3 arranged side by side. Furthermore, in a known manner, a pumping station comprises pumps R (see FIG. 4) for sending the water exiting the heat exchanger 13-based cooling circuit 11 to a discharge shaft 14 leading to an outflow tunnel 4 which ends in underwater mouths 41 located at a distance from the water intakes 51 and 52. The flow rate I_{R} of water discharged by the outflow tunnel 4 is normally equal to the sum of flow rates I₁ and I₂.

The channel 6 comprises an intake portion 60 which communicates with the sea 5, and is protected from the sea by a dike 61 between the channel and the shoreline 5B. A wall 62, for example in the form of a dam wall, creates a separation between the bottom portion 63 and the intake portion 60 of the channel, so that water from the suction basin 2 does not mix with the water of the intake portion of the channel. In this manner, water from the suction basin 2 is not heated by the generally warmer water of the channel 6. The wall 62 and the tunnel and suction shafts may be constructed as part of modifications to a nuclear power plant already in operation where the suction basin was originally formed by the channel 6, in order to lower the maximum temperature of the water supplied to the plant pumping station.

In the unlikely event of damage to both arms of the suction tunnel 3, for example in areas 55 of the tunnel suffering a critical collapse as schematically represented in FIG. 3, there could be significant localized narrowing of the inside cross-sectional area of the tunnel. Studies conducted by the applicant allow one to assume that with a tunnel containing reinforcing wall segments that can move in a direction transverse to the tunnel, and in the most serious collapses considered, the inside cross-sectional area of the tunnel in the damaged areas would remain sufficient to allow a flow rate for example of at least 5 m3 per second of water and greater than the emergency flow rate required by the backup pumps in the pumping station 10. An emergency flow rate of about 4 m3 per second of water is usually enough to cover the water supply requirements of a pumping station of a reactor unit where the generation of electricity has been stopped.

Nevertheless, the current state of research does not allow predicting with certainty that the inside cross-sectional area of the tunnel would systematically remain sufficient in all possible cases of collapse. One cannot completely rule out the possibility of severe narrowing of the inside cross-sectional area of the tunnel, more or less cutting off the water supply to the suction basin 2 which means sufficient water is prevented from reaching the backup pumps from the suction tunnel. The case of a critical collapse as represented in FIG. 3 could therefore lead to cooling failure of the nuclear reactor, even during reactor shutdown. For these reasons, the applicant has sought to design a system for supplying additional water that is capable of placing the suction basin in communication with an emergency water reserve, said system being intended to ensure that the supply of water to the suction basin from the emergency water reserve is infallibly triggered whenever the flow of water from the suction tunnel becomes insufficient to supply the backup pumps.

In the following description, it is assumed that the body of water 5 is a sea subjected to tides. It is understood that the embodiment described is also suitable for a body of water having no substantial variation in level. Each wall of the passage 7 ends at the suction basin 2 at a level which is substantially below the level L_{L} of the lowest tide during the largest tidal coefficients (see FIG. 2). Indeed, the supply of water through the suction tunnel 3 to the suction basin is effected by the equilibrium established between levels due to atmospheric pressure. Taking into account the pumping rate of the pumping station 10, the head losses in the suction shafts 8 and tunnel 3 may result in the water level L₂ in the suction basin being several centimeters or tens of centimeters below the level L₁ of the sea measured above the water intakes 51 and 52, the level L₁ in question being averaged between the peaks and troughs of the swell waves. This averaged level L₁ is substantially the same above the water intakes and in the channel 6, which smoothes out the rapid variations in water level due to swells. When the level L₁ of the sea reaches the level L_{L} of the lowest tide, the water level L₂ in the suction basin reaches a level L_{2L} which must be at a certain height above the mouth 7E of the passage 7, to prevent the suction basin from being progressively emptied by the production pumps of the pumping station 10. The height of the suction basin is such that when the level L₁ of the sea reaches the level L_{H} of the highest tide during the largest tidal coefficients, water does not overflow from the suction basin.

In the embodiment represented in FIG. 1, where the suction basin 2 is implemented within a channel 6, the emergency water reserve is preferably formed by the intake portion 60 of the channel which is mostly protected from the waves and ground swells that can be encountered outside the channel in a coastline setting. A filtration system may be provided at the entrance to the channel, not shown in the figure, for example comprising grills that can be cleaned from time to time, to keep the water in the intake portion 60 of the channel free of contaminants such as floating objects or algae. In fact, due to the fact that the water coming through the suction tunnel 3 does not contain such contaminants, a filtration system 12 for the pumping station 10 (see FIG. 2) can advantageously omit the filtration and cleaning means specifically handling these types of contaminants. In an emergency situation where the suction basin 2 must quickly be supplied with water by the intake portion 60 of the channel, we do not want to risk fouling the filtration system 12.

As represented in FIG. 4 as well as in FIGS. 5 to 7, in order to implement the system for supplying additional water, the closed wall 62 is replaced by a partition wall 620 having an opening 65 blocked by an obstructing device in the form of a pivoting valve 9. The valve 9 comprises an obstructing member 90 in the form of a sealing panel that is generally planar, for example substantially rectangular, and pivotable about a pivot shaft 91. The valve 9 further comprises a counterweight means arranged on a side opposite the sealing panel 90 relative to the pivot shaft 91. The counterweight means comprises a main counterweight member 92 located at a fixed distance from the pivot shaft 91. The counterweight means further comprises an adjustable auxiliary counterweight means, which comprises for example an auxiliary counterweight 94 movably mounted on two arms 93 fixed to the valve 9. In this manner, the position of the center of gravity G of the obstructing device 9 can be adjusted to some extent, as detailed below with reference to FIG. 9. The valve 9 is designed such that the center of gravity G is located at a certain distance from the plane of the sealing panel 90, so that the torque exerted by the weight of the valve with respect to the pivot shaft 91 provides a force that keeps the valve closed despite the level L₁ of the sea being higher than the water level L₂ in the suction basin.

In order to have a constant pumping rate of the pumping station 10 supplying water to a heat exchanger 13-based cooling circuit 11, the difference in height Δh between the level L₁ of the sea and the water level L₂ in the suction basin virtually does not vary with the level of the sea. The valve 9 closing force provided by the weight of the valve as explained above is intended to be greater than the valve opening force required by the water pressure differential between the two faces of the sealing panel 90 due to the difference in height Δh, this difference Δh being considered for a pumping rate of the pumping station during normal operation with the corresponding reactor unit at full power. In this manner, as long as the suction basin 2 is supplied with water by a suction tunnel 3 as normal, the valve 9 remains closed as represented in FIG. 4 and FIG. 6, so that there is almost no mixing of the water in the suction basin with the water of the emergency water reserve formed by the intake portion 60 of the channel. It is not necessary for the valve 9 to provide a perfect seal, as it is acceptable for water to leak from the intake portion 60 to the suction basin 2 as long as this does not significantly increase the water temperature in the suction basin.

The valve 9 closing force provided by the weight of the valve is intended to correspond to a predetermined critical difference ΔhV in the water levels that unerringly indicates an insufficient supply of water to the basin 2 via the suction tunnel or tunnels 3. In other words, it is arranged that the valve opening force resulting from this critical difference ΔhV is stronger than the valve closing force once the height difference Δh exceeds the critical difference ΔhV, causing the valve to open once the critical difference ΔhV is reached. In practice, the static friction of the valve's pivoting elements must also be considered, for example the bearings associated with the pivot shaft 91 if the latter pivots on bearings 95 (see FIG. 5 and FIG. 7).

A collapse in a suction tunnel 3 is unlikely to occur precisely during a period when the level L₁ of the sea is as low as the level L_{L} of the lowest tide during the strongest tidal coefficients. As a result, if the critical height difference ΔhV is reached after a collapse in the tunnel, the valve 9 will generally open while the water level L₂ in the suction basin 2 is still above a critical level L_{2V} corresponding to the case of the lowest tide indicated in FIG. 5.

Furthermore, the sizing of the valve 9 may vary depending on the desired function of the system for supplying additional water. It may be desired to allow the water to travel through the valve 9, once it is open, at a rate sufficient to allow normal operation of the pumping station 10 for a reactor unit generating electricity at full capacity during periods where the water temperature at the surface of the sea does not exceed a certain value, for example between 10° C. and 20° C. The repair of a suction tunnel having experienced a collapse may take months or even more than a year for a critical collapse in several arms of the tunnel. Electricity generation by the nuclear power plant could then be continued during some or all of the work period, particularly in the winter, by using the channel 6 to supply water to the suction basin 2. As an alternative to a valve 9 of large dimensions to accommodate the maximum flow rate required for electricity generation, a valve 9 of smaller size can be provided, arranged in parallel with a main gate valve such as a raising gate installed beside valve 9 within the partition wall 620. The main gate valve, not shown in the figures, would be controlled to open after valve 9 is triggered, the opening of the gate valve being required in order to restart the production pumps.

In other configurations of nuclear power plants, for example in the case of a nuclear power plant installed near a sea that remains relatively warm year round, normal operation of the pumping station 10 to generate electricity at full capacity may be impossible if the water must be supplied to the suction basin through the channel 6. In this case, valve 9 can have relatively small dimensions that allow sufficient water through to achieve a minimum flow rate, for example about 5 m3 per second, for reliably supplying the backup pumps of the pumping station 10 with the water required. It is also conceivable for valve 9 to have sufficient dimensions for supplying the production pumps with a reduced flow, in a context of reduced electricity production by the plant.

The dimensions of the suction basin 2 should take into account the extreme case where a critical collapse in the suction tunnel 3 occurs during a period when the level L₁ of the sea has reached the level L_{L} of lowest tide during the strongest tidal coefficients. Just before the supply of water from the passages 7 connected to the suction tunnel is cut off, the water level L_{2L} in the suction basin is at a height below level L_{L}. Once the water supply is cut off or is at least insufficient for the water consumed by the pumping station 10, a more or less rapid drop in the water level in the suction basin occurs, to reach the critical level L_{2V} as shown in FIG. 5. As explained above, the valve 9 is then forced to pivot open. In addition, a system for detecting the water level and/or the pivoting of the valve 9 may advantageously be provided, for forcing shutdown of electricity production and a switch from the production pumps of the pumping station 10 to the backup pumps.

The filtration system 12 is arranged below the critical level L_{2V}, and the water intakes of the pumping station 10 are arranged sufficiently below this level to avoid their exposure as the water level in the suction basin continues to drop during the shutdown phase of the production pumps. Depending on the flow rate of the water through the open valve 9, the water level in the suction basin will climb back more or less quickly, and at the latest once the production pumps have completely stopped. Thanks to the counterweight means of the valve 9, the positioning of the center of gravity G of the obstructing device above the level of the pivot shaft 91 allows the torque exerted by the weight of the valve about the pivot shaft 91 to decrease as the valve opens. As a result, the valve remains open in a position of dynamic equilibrium which is maintained when the height difference Δh of the water is once again less than the critical difference ΔhV.

The valve 9 described above is an obstructing device in which the pivoting occurs autonomously, meaning in a passive manner without requiring an external device to trigger it. Optionally, the pivoting of the valve 9 can be actuated by a trigger device connected for example to a control system associated with a water level detection system. The trigger device may, for example, act on a cable connected to a crank attached to the valve at the pivot shaft 91, and may advantageously be adapted to allow the valve to pivot autonomously in the event that the trigger device does not function. The trigger device may also be arranged to maintain the valve 9, after it is triggered, in a position where it is more widely open than in the dynamic equilibrium position mentioned above with reference to FIG. 5.

As represented in FIG. 6 and FIG. 7, the auxiliary counterweight 94 may be formed by a beam structure mounted to be slidable perpendicularly to two arms 93 parallel to each other, in a manner that adjusts the distance between the beam 94 and the pivot shaft 91 parallel to it. In addition, the opening 65 forming the water duct in the wall 620 separating the suction basin 2 from the intake portion 60 of the channel may be provided with a filtration and/or safety grid on the intake portion 60 side.

Advantageously, the main counterweight member 92 weighs between 80% and 200% of the weight of the obstructing member 90. In this manner, as represented in FIG. 8, the center of gravity G1 of the assembly of the two members is relatively close to the pivot shaft 91 within a height range DG1. To raise the position of the center of gravity G1, the weight of the main counterweight 92 can be increased and/or the position of its center of gravity raised. The auxiliary counterweight means attached to this assembly is arranged such that the center of gravity G of the entire assembly is located above the level X of the pivot shaft 91, as represented in FIG. 9. Adjusting the position of the auxiliary counterweight 94 in a direction A1 within a certain margin DG2 moves the center of gravity G2 of the auxiliary counterweight means, and therefore moves the center of gravity G more or less further away from the pivot shaft 91. Thus, if during testing or normal operation the valve 9 is opened unexpectedly while the suction tunnel is functioning, for example during a storm hitting the coastline 5B, the position of the auxiliary counterweight 94 can be readjusted to correspond to a critical height difference ΔhV that has been reevaluated upward.

The main counterweight member 92 and the device comprising the auxiliary counterweight 94 may form an assembly that is a single piece for all intents and purposes, which is secured to the obstructing member 90 by fitting it thereon, as represented in FIG. 10.

Another embodiment of a system for supplying additional water is represented in FIGS. 11 to 14, for a water intake installation according to the invention. In comparison to the previous embodiment, this embodiment allows reducing the dimensions of the obstructing device 9, and in particular the dimensions of the obstructing member 90. As represented in FIG. 11 and FIG. 12, the opening 65 forming the water duct in the wall 621 separating the suction basin 2 from the intake portion 60 of the channel is arranged in a lower portion of the wall 621. A sealing panel that is generally planar, for example substantially rectangular, forms the obstructing member 90 of the valve 9. The dimensions of the sealing panel 90 are somewhat larger than the cross-sectional area of the passage of the opening 65, said cross-sectional area possibly being relatively small, for example about 2 to 3 m2, to permit only the passage of enough water to supply reliably the backup pumps of the pump station 10. As explained for the previous embodiment, it is also possible to arrange in parallel a main gate valve such as a sliding gate valve actuated by a control, also known as a slice valve, installed beside valve 9 in the partition wall 621.

The pivot shaft 91 of the valve 9 is attached at a lower edge of the sealing panel 90. The pivot elements of the valve comprise, for example, the bearings associated with the pivot shaft 91 and arranged to rotate on bearing mounts on the bottom of the suction basin. Pneumatic caissons or hollow watertight columns may be provided, each having a wall traversed by the pivot shaft 91, in order to contain the bearings and mounts and surround them with air. As an alternative to the bearings, it may be arranged that the pivot shaft 91 is formed by a bar having a ridge for example of stainless steel along its length, which presses against the inner surface of a half-tube or similar bearing element having a concave face parallel to the bar and attached to the ground at the bottom of the basin. The concave face of the bearing element will generally be oriented towards the intake portion 60 of the channel, to prevent movement of the pivot shaft 91 in the direction of the suction basin including after the valve 9 has pivoted as represented in FIG. 12. The static friction of such a device with its ridged pivot shaft can be fairly low, and in particular can be relatively stable over time without requiring special maintenance of the device.

The sealing panel 90 is installed within the opening 65 in the wall 621 so as to seal the opening in a more or less fluidtight manner, and is mounted with a certain inclination relative to the vertical direction. An abutment maintaining the inclined position of the panel 90 is formed for example by a shoulder 622 of the wall 621. The inclination and weight of the panel 90 are defined beforehand so that the panel remains in position during situations of normal operation of the suction tunnel, as shown in FIG. 11. In other words, the panel 90 must not pivot under normal conditions, despite the differential water pressure on the face of the panel on the channel side due to the height difference Δh between the level L₁ of the sea and the water level L₂ in the suction basin, but must pivot to open the valve 9 if the critical height difference ΔhV is reached as represented in FIG. 12.

The valve 9 does not require a massive counterweight member such as the main counterweight member 92 described above. In fact, once the panel 90 begins to pivot, the inclination of the panel relative to the vertical direction decreases, which reduces the torque exerted by the weight of the panel relative to the pivot shaft 91 and therefore decreases the resistance of the valve to the opening force caused by the critical height difference ΔhV. The valve 9 is therefore certain to open fully when the panel 90 starts to rotate.

In FIG. 13, a variant of the system for supplying additional water of FIG. 11 consists of providing the valve with an adjustable counterweight means comprising, for example, a counterweight 94 movably mounted on two parallel arms 93 fixed to the valve 9, in a manner analogous to the auxiliary counterweight means 94 described above in reference to FIG. 4 and FIG. 6. Furthermore, in order to optimize the cross-sectional area of the opening 65 in the partition wall 621, the floor is sunken under the counterweight 94, and the abutment maintaining the inclined position of the panel 90 is formed near the pivot shaft 91. A relatively light counterweight 94, for example weighing less than 10% of the weight of the panel 90, can be sufficient for tests adjusting the center of gravity G of the valve.

As represented in FIG. 13, the valve 13 is subjected to two opposing torques, meaning torques in opposite directions relative to the pivot shaft 91. The torque exerted by the weight of the valve is equal to the value F1 of the weight multiplied by the distance D1 between the weight vector applied at the center of gravity G of the valve and the center axis C of the pivot shaft 91. The algebraic torque exerted by the force of the differential water pressure that is applied to the panel 90 is equal to the algebraic value F2 of this force multiplied by the distance D2 between the force vector F2 and the central axis C. The angle of the panel 90, as well as the center of gravity and the weight of the valve, are defined beforehand so that the two opposing torques have the same absolute value if the critical height difference ΔhV in the water levels is reached. As represented in FIG. 14, when the critical height difference ΔhV is slightly exceeded this overcomes the static friction of the device with its pivot shaft 91, causing the panel 90 to pivot which opens the valve 9. The water level L₂ in the suction basin may continue to descend as long as the production pumps are not completely shut down, and climbs back up when only the backup pumps are active.

Another embodiment of a system for supplying additional water similar to the one of FIG. 11 for a water intake installation according to the invention is represented in FIG. 15. The implementation of the obstructing device 9 in particular is different from the previous embodiment, especially in that the sealing panel 90 is not the only sealing element of the valve 9 between the suction basin 2 and the intake portion 60 of the channel. Indeed, here a main counterweight member 92 as previously described forms a sealing surface S3 on the side of the panel 90 away from the pivot shaft 91. In this manner, torque exerted due to the force F3 of the differential water pressure which is applied to the sealing surface S3 is added to the torque exerted by the weight F1 of the valve, in a direction of rotation opposing the torque exerted by the force F2 of the differential water pressure which is applied to the panel 90.

This implementation of the valve 9 keeps the valve closed until there is a relatively large critical height difference ΔhV, without requiring a particularly massive counterweight system. Indeed, the design may provide for increased dimensions of the sealing surface S3 in order to adapt the valve for a greater critical height difference ΔhV. In addition, as represented in FIG. 16, once the valve 9 is open it exposes a water duct having a cross-sectional area virtually equal to the cross-sectional area of the opening 65. In addition, depending on the intended position of its center of gravity G, the valve may be arranged to close autonomously if the operation of the suction tunnel is restored. Optionally, a filtration and/or safety grid 12′ may be provided on the opening 65 on the suction basin 2 side.

A system for supplying additional water for a water intake installation according to the invention may comprise a backup tunnel, in particular if the suction basin is at a distance from the emergency water reserve. This may be the case, for example, if the nuclear power plant is separated from the sea by a section of land where construction is not possible, thus preventing the construction of a channel to the suction basin but allowing the passage of a backup tunnel beneath said section of land. This may also be the case, for example, if the power plant is located next to a body of water likely to experience an unusual rise in water level.

In FIG. 17, a water intake installation according to the invention can be adapted for such a nuclear power plant located next to such a body of water. An unusual rise in water level is understood to mean a tidal wave such as those caused for example by a tsunami, or floodwaters swelling a river. A water intake installation such as the one represented in FIG. 1 requires relatively few arrangements to withstand an unusual rise in water level. The dike 61 must be of sufficient height to prevent flooding if the body of water 5 reaches the height L_{1P} of the highest estimated level. In addition, the dike 61 must protect the plant completely, and therefore there is no longer any question of an opening to the sea such as a channel. To simplify the description, it is considered in the following that the body of water 5 is a sea, but it is understood that the installation described also relates to any body of water suitable for cooling a plant, such as a river for example.

Advantageously, the mouth 7E of a passage 7 connecting the suction basin 2 to the suction tunnel 3 is located at a predetermined height above the bottom 2B of the suction basin, so that in the event of an exceptional drop of the sea to below the level L_{L} of the lowest tide, as can occur for example along the coastline in areas prone to tsunamis, a certain volume of water remains as a reserve in the suction basin. In the most critical estimate of the drop in the sea level, the level L₁ of the sea will remain below the level of the mouth 7E of the passage 7 for a certain period of time, which means that during this time, which may last several minutes, the water to the pumping station 10 will only be supplied from the reserve volume of water. This volume of water must therefore be arranged so that there is time to shut down the production of electricity by the nuclear reactor and to switch from the production pumps of the pumping station 10 to the backup pumps, and to do so with no risk of interruption of the water supply to the backup pumps. It must be possible to supply the backup pumps from the reserve volume of water until the sea rises sufficiently for the water in the passage 7 to return to above the level of the mouth 7E of the passage, meaning until the tunnel 3 is again supplying the suction basin. As a first approximation, it is estimated for example that a reserve volume of water of about 10,000 m3 for a pumping station for one nuclear unit is sufficient to offset the most critical drop possible in the level of the sea prior to a first wave of a tsunami, lasting at least fifteen minutes or so.

To avoid an uncontrolled overflow of the suction basin 2 during an unusual rise in the sea, for example during or after a first wave of a tsunami, the basin is covered by a device forming an essentially watertight cover 25. Calibrated openings 26 can be made in or near the cover 25, for example in a side wall of the basin between the basin and its outside environment. In this manner, if the basin 2 is completely filled, the calibrated openings 26 allow a limited flow of water Iₚ from the basin to the outside environment. The flow Iₚ may be channeled to a small basin 22 formed on a cover of a compartment 21 of the suction basin 2, before being discharged for example into the sea at low tide.

In addition, as explained above with reference to FIG. 1 and FIG. 4, in a nuclear power plant 1A the water leaving the heat exchanger 13-based cooling circuit 11 is drained into a discharge shaft 14 for discharge into the sea via an outflow tunnel 4. In the event of an unusual rise of the sea, uncontrolled overflow of the discharge shaft must be avoided. Advantageously, the discharge shaft 14 is also provided with a cover device with at least one calibrated opening to allow a limited flow of water to outside the discharge shaft in the event of overflow. This arrangement applies to any nuclear power plant comprising a water intake installation of the invention and likely to experience an unusual rise in the level of the body of water 5. Furthermore, in order to counter the possibility of a relative blockage of the outflow tunnel 4, the discharge shaft 14 may advantageously be provided with a closed valve which opens to the outside only beyond a certain water pressure in the shaft, or an obstructing device which is controlled to open so that it is in communication with an auxiliary outflow passage leading to the sea. In the event of blockage of the outflow tunnel 4, the water level in the discharge shaft 14 will rise due to the water contributed by the pumps R (FIG. 4), and the valve or the obstructing device is triggered to open shortly before the level reaches the top of the shaft in order to drain the water away by the auxiliary outflow passage.

The maximum water pressure in the suction basin 2 at the cover 25 is a function of the highest level L_{1P} of the sea directly above the water intakes 51 and 52, relative to the cover 25. The depressurization in the suction basin 2 will be more or less significant, depending on the flow of water I_{P} through the calibrated openings 26. It is possible to dispense with the openings 26 and replace them with valves that allow air to enter and prevent water from exiting. In this case, the structures of the basin 2, the cover 25, and the filtration system 12, must withstand the added pressure.

The water intake installation further comprises a system for supplying additional water that is functionally analogous to the one described above with reference to FIG. 4, and that includes a water duct in the form of a backup tunnel 30 connected to at least one backup water intake 15 submerged in the sea. A backup water intake 15 must be submerged at a depth that ensures it is never exposed except in the case of an extremely exceptional drop in the sea as can occur before the arrival of the first wave of a tsunami, and therefore is located below the level L_{L} of the lowest tide during the strongest tidal coefficients. It is generally not necessary for a backup water intake 15 to be arranged more than ten meters below level L_{L}, an arrangement of less than ten meters below this level L_{L} generally being sufficient to prevent contamination of the water intake by floating objects or algae. A main water intake 51 or 52 is generally arranged at more than twenty meters below the level L_{L} of the lowest tide, so that the decrease in the maximum temperature of the water it draws is significant. A backup water intake 15 will therefore usually be positioned at a height H_{E} of at least ten meters above a main water intake.

The backup tunnel 30 passes under the dike 61 and comprises a horizontal passage 35 which traverses a wall of the suction basin 2 to open into the basin at an end 35B that forms a vertical planar surface. An obstructing device 9 in the form of an autonomous pivoting valve, which may be virtually identical to the one described above with reference to FIG. 4, is installed in the suction basin 2, for example in a compartment 2B of the basin providing maintenance access to the valve without the risk of objects or workers being sucked into the main chamber 2A of the suction basin. An opening 21 provided between the compartment 2B and the chamber 2A may be equipped with a security grid. In the closed position of the valve 9, the planar sealing panel 90 forming the obstructing member of the valve is seated against the end 35B of the backup tunnel 30 and thus closes off the water duct.

As represented in FIG. 18, in the case of an insufficient supply to the pumping station 10 of water coming from the suction tunnel, the water level L₂ in the suction basin 2 drops until the predetermined critical difference ΔhV between the level L₁ of the sea and the level L₂ of the basin is exceeded, which causes the valve 9 to pivot and therefore opens the water duct. The water coming from the sea through the backup tunnel 30 passes into the compartment 2B of the basin and then into the main chamber 2A of the basin through the opening 21.

It is understood that the obstructing device of the system for supplying additional water of FIG. 17 is not limited to a valve 9 with a massive counterweight means. For example, a valve device 9 as described above with reference to FIG. 11, FIG. 13, or FIG. 15, may instead be provided in the compartment 2B of the suction basin, with the passage 35 being suitably adapted.

As represented in FIG. 19, according to another embodiment of the obstructing device, the pivoting valve device 16 comprises a float device 96, arranged so as to be fully submerged in water during a normal supply of water by the suction tunnel 3. The volume of the float device 96 is defined beforehand so that the buoyancy exerted on the fully submerged float is sufficient to keep the valve 16 closed during a normal supply of water, by counterbalancing the opening force of the valve due to the differential water pressure exerted on the face of the sealing panel 90 on the backup tunnel 30 side. The float 96 has a structure adapted to withstand the high water pressure in the suction basin 2 in case of tidal waves.

In a case of insufficient water supply to the pumping station 10, if the level of water L₂ in the suction tank 2 falls sufficiently below the level L_{2L} of lowest tide to reach the predetermined trigger level L_{2V}, the float 96 is designed to emerge at least partially from the water, so that the decrease in buoyancy exerted on the float causes the valve 16 and thus the obstructing member 90 to pivot. Advantageously, the volume and weight of the float device 96 are defined beforehand so that if the critical difference in water level ΔhV is exceeded, the valve opening force due to the water pressure differential is greater than the valve closing force due to the torque of the floating device with respect to the pivot shaft 91. Thus, once the level L₁ of the sea is substantially above the level L_{L} of the lowest tide during the strongest tidal coefficients, the valve 16 begins to pivot to open the water duct as soon as the predetermined critical difference in water level ΔhV is exceeded.

A significant advantage of such a valve 16 with its float device 96 lies in that it is virtually certain that the valve will pivot autonomously, at the very latest shortly after the water level L₂ in the suction basin drops below the trigger level L_{2V}. Even assuming some seizing of the pivot shaft 91 or adherence of the panel 90 to the end 35 of the passage due to organic matter, the drop of the water level L₂ to below the trigger level L_{2V} exposes the float 96 to the point where the valve opening force inevitably becomes sufficiently strong to overcome the static forces preventing pivoting. For example, with a water level L₂ as indicated in FIG. 19, one can see that the valve 16 cannot remain closed and it pivots to open as represented. It is understood that such a valve with float device may also be used as an obstructing device in place of valve 9 in a system for supplying additional water such as that of FIG. 4.

A possible disadvantage of the device lies in the limitation to how far the valve can pivot, which may not allow sufficient flow of water through the backup tunnel 30 if the production pumps of the pumping station 10 are restarted during periods when the water temperature at the sea's surface remains cold. In this case, one solution would be to provide a sufficient cross-sectional area of the backup tunnel 30 and the passage 35, and to have a controlled valve appropriate for a large cross-sectional area in parallel with the valve 16 which in turn may be arranged to simply allow a water flow certain to be sufficient to supply the backup pumps of the pumping station. In addition, the pivot shaft 91 may be formed by a bar having a supporting ridge along its length as explained above in relation with the embodiment shown in FIG. 11, which should prevent significant seizing of the shaft without requiring special maintenance.

Moreover, if the high water is due to a tsunami, and if no significant earthquake before the tsunami is felt in the plant, it may be desirable not to shut down the reactor units in the plant and therefore not to shut down the production pumps in the pumping station during the high water. A water intake installation such as the one described above with reference to FIG. 17 and FIG. 18 allows such operation. However, as explained above, during this period which may last several minutes, the supply of water to the production pumps must then be able to occur solely from the reserve of water contained in the suction basin 2 below the mouth 7E of the passage 7. As a first approximation, it is estimated for example that a reserve volume of water of up to about 100,000 m3 for a pumping station of a reactor unit would be needed to overcome the most critical drop conceivable in the level of the sea preceding the first wave of a tsunami, lasting at least fifteen minutes. For example, with a height of at least five meters between the bottom 2B of the basin 2 and the mouth 7E of the passage 7, it would take about two hectares of basin surface area to ensure such a reserve volume of water.

There are disadvantages to creating a suction basin such as the one in FIG. 17, for the case of a particularly large reserve volume below the level of the mouth 7E of the passage 7. First, since the basin has a roof that forms a cover resistant to a water pressure in the basin of for example about two bar in order to contain the water in case of tsunami or tidal wave, the implementation of such a roof to cover an area of a hectare or more involves significant construction costs. This is even more true if the suction basin 2 is shared by multiple pumping stations supplying several reactor units, where the surface area of the basin roof substantially increases the construction costs of the water intake installation as a whole. Furthermore, since the pumping rate of a pumping station when supplying a reactor unit in full production is about 70 m3 per second for example, it would take almost an hour at a flow rate of about 140 m3 per second to refill completely a suction basin shared by two reactor units and containing about 500,000 m3 measured as the high tide average. Depending on the temperature of the outside air, especially if the outside temperature exceeds 30° C. in the shade, the water flowing into the basin could grow warmer by about 1° C. or more between when it exits the suction tunnel and enters the pumping station. A relative decrease in efficiency of the facility may therefore occur during certain times of the year, in comparison to a suction basin of much smaller volume.

To overcome these potential disadvantages, an embodiment of a water intake installation of the invention proposes establishing an emergency water reserve in a reserve basin containing a volume of water which remains substantially unchanged while water is being supplied normally to the suction basin by the suction tunnel or tunnels.

An example of such an embodiment is represented in FIG. 20. A reserve tank 20 is separated from the suction basin 2 by a dam wall 80 in which is provided with an opening 85 forming a water duct for the system for supplying additional water. The water duct 85 opens into the suction basin 2 in a curved side of the wall 80 forming a circular arc or some other continuous curve in a vertical plane corresponding to the plane of the figure. An obstructing device 17, shown in its closed position in the figure, comprises an obstructing member in the form of a sealing panel 90′ associated with a supporting structure, the panel having an outer surface of a shape substantially complementary to the curved side of the wall 80. The panel 90′ with its supporting structure is connected to a horizontal pivot shaft 91′ on which it pivots to bring the obstructing device 17 to a position which opens the water duct 85 as shown in FIG. 21. The pivot shaft 91′ may substantially be coincident with a straight line forming the central axis of curvature of the curved side of the wall 80. Since the widest pivot angle of the obstructing device 17 is less than 90°, and here is even less than 45°, it may be arranged that the pivot shaft 91 is formed by a bar having ridges along its length that are in alignment with a same straight line and that face towards opposite sides and press against concave mount surfaces, thus providing a submerged pivot shaft that does not require lubrication.

The outer surface of the sealing panel 90′ is arranged to be flush with the surface of the curved side of the wall 80 when the obstructing device 17 is in the closed position, leaving only a small gap allowing a limited flow of water to escape from the reserve basin 20 to the suction basin 2 when the water duct 85 is closed off. However, the gap between the sealing panel 90′ and the curved side of the wall 80 is sufficient to prevent any risk of the panel catching on the wall, the thickness of the gap being able to fluctuate for example with the thermal expansion of the supporting structure of the panel. Too thin of a gap could allow contact where the panel and the wall become jammed, preventing the obstructing device 17 from opening.

The obstructing device 17 comprises a counterweight means arranged on the side opposite to the obstructing member 90′ relative to the pivot shaft 91′. The counterweight means comprises a main counterweight member 97 including a supporting structure rigidly connected to the supporting structure of the panel 90′. The obstructing device 17 is designed to begin pivoting from its closed position as soon as the water level in the basin reaches a predetermined trigger level L_{2V} at which a substantial portion of the main counterweight member 97 emerges from the water. The main counterweight member 97 preferably weighs between 80% and 200% of the weight of the obstructing member 90′. For example, a weight approaching 200% of the weight of the obstructing member allows placing the pivot shaft 91′ and main counterweight member 97 closer together, thereby reducing the overall size of the obstructing device 17 and in addition allowing a wider pivot angle and thus a wider opening of the device for a given decrease of the water level in the suction basin. In addition, the counterweight means may comprise an auxiliary counterweight movably mounted on the supporting structure of the main counterweight. In addition, in order to reduce the surface area of the suction basin floor, thereby reducing the surface area of the roof forming the cover device 25 of the basin, it is possible to install at least one obstructing device 17 between two mouths 7E of two passages 7 connecting the tunnel 3 to the suction basin 2.

The floor of the reserve basin 20 extends over a much greater surface area than the suction basin 2, and its top is open to the outside. The reserve basin 20 does not require a waterproof roof, although a system of protection against the sun's rays, for example a tarpaulin, remains possible. The water level L₃ in the reserve basin 20 is kept relatively constant, below the cover device 25 of the suction basin. For example, pumps to circulate water in both directions between the suction basin and the reserve basin may be provided, to compensate for the continuous leakage of water into the suction basin through the obstructing device 17 or conversely to discharge water into the suction basin during heavy rains. The volume of water in the reserve basin 20 remains substantially unchanged as long as the suction basin is being supplied with water normally by the suction tunnel or tunnels. For a nuclear power plant where the suction basin supplies water to two reactor units, a reserve basin 20 containing for example about 100,000 m3 of water seems sufficient to overcome the most critical drops conceivable in the level of the sea.

The difference in height between the water level L₃ in the reserve basin 20 and the water level L₂ in the suction basin 2 can be significant, particularly at low tide, and for example can reach about ten meters at the lowest tide of the year for an ocean. As a result, a differential water pressure on the order of a bar at its peak is applied to the sealing panel forming the obstructing member 90′ between the reserve basin 20 and the suction basin 2. In addition, the water duct 85 closed off by the sealing panel 90′ must have a sufficient cross-sectional area to allow a flow of water enabling the production pumps of a pumping station to continue to operate, for example about 70 m3 per second, which implies a relatively large surface area for the sealing panel 90′. The forces generated by the differential water pressure on the sealing panel 90′ result in a force represented in FIG. 20 by a vector F2 which is applied at or near the geometric center of the surface of the sealing panel blocking the water duct 85. This force vector F2 is directed perpendicularly to the central axis of curvature of the curved side of the wall 80, which may be designed to be coincident with the pivot shaft 91′, such that the force vector generates no torque on the sealing device 17. Advantageously, the central axis of curvature of the curved side of the wall 80 may be located somewhat above the pivot shaft 91′, such that the force vector F2 directed perpendicularly to this central axis generates a torque on the obstructing device 17 that helps the device to pivot open. This latter arrangement may be of interest for reducing the weight necessary for the main counterweight member 97, as long as the volume of this member remains sufficient for the buoyancy required when the obstructing device 17 is in the closed position.

In the embodiment represented in FIG. 20, the system for supplying additional water can provide indirect communication between the suction basin 2 and a second emergency water reserve consisting of the body of water 5, which is the sea in this example. In the case where the supply of water to the suction basin by the suction tunnel or tunnels becomes insufficient for a lasting period, and in particular in the case of a critical collapse in the suction tunnel or tunnels, a lasting solution must be implemented for supplying water to the suction basin once the volume of water in the reserve basin 20 has severely decreased. Given the proximity of the sea, it is advantageous to provide a water duct in the form of a backup tunnel 30 connected to at least one backup water intake 15 submerged in the sea, as described above in reference to FIG. 17. It is understood that if the plant is located near a water source such as a river or lake providing the possibility of a reliable and sustainable source for the second emergency water reserve, a link for supplying water between such a water source and the reserve basin 20 may possibly be preferred over the solution of a backup tunnel 30. For example, a small artificial lake of seawater maintained at a certain level by pumping water from the sea could be provided at or near the site of the nuclear power plant, at a height slightly above the reserve basin 20 and connected to the reserve basin or directly to the suction basin through a pipe closed off by a valve.

Given that the reserve basin 20 is not closed off by a cover device, the obstructing device sealing the water duct created by the backup tunnel 30 must not allow seawater to enter the reserve basin in case of a tidal wave, because the reserve basin could then overflow and risk flooding the plant. Therefore, a sealing device such as the device 9 referenced in FIG. 17 is not appropriate for the reserve basin 20. In addition, when the water level in the suction basin 2 drops in a manner defined beforehand as abnormal, it may be advantageous to detect the state of the sea's level to determine whether the decreased level in the suction basin is caused by the sea abnormally retreating. If the level of the sea has not changed significantly, leading to the conclusion that a critical collapse has occurred in the suction tunnel or tunnels, the production pumps of the pumping station can be shut down and switched over to the backup pumps. The volume of water in the reserve basin 20 is usually enough to supply water to the backup pumps for at least two hours. As this provides the time to open the obstructing device blocking the backup tunnel 30, an obstructing device in the form of a non-autonomous controlled valve, for instance a gate valve, is possible. Unlike an autonomous valve, such an obstructing device does not provide a passive safety mechanism, and once the valve is open it must be possible to ensure its closure in the event of a tidal wave.

An autonomous obstructing device similar to device 17 may be used to close off the backup tunnel 30. Alternatively, a pivoting float device 18 may be employed that does not require a counterweight. The obstructing device 18 represented in FIG. 20 comprises a curved sealing panel 90′ pivoting about a pivot shaft 91′ which can be arranged to coincide with the straight line forming the central axis of curvature of the curved face of the panel. A float 98 is attached to the supporting structure of the sealing panel and is adapted to push the structure upward as long as the float is completely submerged. A small adjusting counterweight can be added to the device, in order to adjust the pivoting that is triggered when the float rises above the water surface.

As represented in FIG. 21, during a critical drop in the level of the sea preceding the first wave of a tsunami, the sea withdraws to below the level L_{L} of the lowest tide for a period of several minutes. The level L₂ of the water in the suction basin 2 first drops very quickly because the water flows back toward the passages 7 where the water level is attempting to establish an equilibrium with the level L₁ of the sea. The rapid exposure of a large portion of the main counterweight member 97 of the obstructing device 17 greatly decreases the buoyancy exerted on this member and causes an almost complete opening of the closing device, allowing the reserve basin 20 to supply water to the suction basin 2 in a limited flow but designed to be sufficient for the production pumps if these have not been shut down. The obstructing device 17 is arranged such that level L₂ stabilizes at a height slightly below the mouths 7E of the passages 7, so that as little water as possible is lost from the reserve basin through the passages 7. One will note that if level L₂ climbs back up slightly, the obstructing device 17 pivots and somewhat obstructs the water duct 85, which reduces the flow so that level L₂ can stabilize as represented in FIG. 21. Furthermore, it may be advantageous to detect the state of the sea's level in order to check whether the decreased level in the suction basin is caused by an abnormal withdrawal of the sea. In this case, and if no significant earthquake preceding the tsunami was felt in the plant, it is not necessary to shut down the production pumps which can continue to be supplied with water by the reserve basin until the water returns to the suction basin via the suction tunnel or tunnels. Even so, it may be decided when designing the plant that the production pumps will be shut down systematically in the event of an abnormally low water level in the suction basin, thus limiting the volume required in the reserve basin and therefore the construction cost of the basin.

When the first wave of the tsunami arrives, as represented in FIG. 22, the sea can reach a level L_{1P} located several meters above the cover device 25 of the suction basin. The water in the suction basin rises, which causes the obstructing device 17 to close. Once the water in the suction basin has reached the cover 25, a limited flow of water I_{P} is allowed to exit to the outside environment through the calibrated openings 26. This flow I_{P} can be channeled to the reserve basin 20, where the water level L₃ is still far below the maximum capacity of the basin. The obstructing device 18 which blocks the backup tunnel 30 is not triggered to pivot by the differential water pressure applied to its obstructing member 90′, since the pressures result in a force vector F2 directed toward the pivot shaft 91′. The operation of the nuclear power plant can be continued in this tidal wave situation during the period required for the sea to return to its normal level, for example about half an hour.

In FIG. 23, one can see that a critical collapse has occurred in the suction tunnel or tunnels in at least one collapse area 55. The water level L₂ in the suction basin 2 has dropped which has caused the obstructing device 17 to open, significantly draining the reserve basin 20 into the suction basin to achieve substantially the same level L₂. During this water transfer period, the production pumps of the pumping station were shut down and switched over to the backup pumps. The float of the obstructing device 18 has been partially exposed above the surface of the water, causing the partial opening of the obstructing device and thus supplying the reserve basin 20 via the backup tunnel 30. The partial opening of the obstructing device 18 adjusts automatically to the water consumption of the pumping station, because if the level L₂ drops too much the obstructing device 18 opens further until equilibrium is restored.

As represented in FIG. 24, the pivoting of an obstructing device 17 or 18 to open it, and possibly also to close it, may optionally be actuated by a trigger device 70 connected for example to a control system associated with at least one water level detection system. The trigger device 70 may, for example, comprise a winch possibly on a crane, acting on a cable 71 connected to the structure of the obstructing device. Such a trigger device has the advantage of allowing the obstructing device to pivot automatically if the winch is not activated. In the example shown in FIG. 24, once the suction tunnel 3 is repaired and the suction basin 2 is being supplied with water normally, the trigger device is actuated to force open the obstructing device 18 in order to fill the reserve basin via the backup tunnel 30 while the sea is at high tide. Considering the situation of a critical collapse of the suction tunnel 3 in reference to FIG. 23, one will note that the installation of trigger devices 70 as represented in FIG. 24 would allow keeping the obstructing devices 17 and 18 completely open if it is desired to increase the flow of water between the backup tunnel 30 and the suction basin 2, making it possible to restart the production pumps.

In addition, during the design phase one could provide means for securing the obstructing device 18 in its closed position, or for removing the obstructing device 18 and sealing the water duct formed by the backup tunnel 30. Once sufficient experience has been obtained with the operation of nuclear power plants supplied with water through reinforced suction tunnels, it is found out that a critical collapse in a suction tunnel cannot reduce the flow of water to the point that it impacts the water supply to the backup pumps, it could be decided to temporarily or definitively block off the water duct provided by the backup tunnel. In such a scenario, it might even be possible to do without a backup tunnel in the construction of new water intake installations of the invention similar to the installation of FIG. 20. The proximity of the sea in this case allows providing emergency solutions for supplying water to the reserve basin 20 if so needed.

In FIG. 25, another embodiment of a water intake installation according to the invention is represented that is similar to the embodiment described above with reference to FIG. 23. These essentially differ in that the suction basin 2 is directly supplied with water by a backup tunnel 31 connected to at least one backup water intake 15 submerged in the sea. For the purposes of the diagrammatic representation in FIG. 25, the backup tunnel 31 is represented as passing through the reserve basin 20 to end in a horizontal pipe 36 traversing a face of the dam wall 80 separating the reserve basin 20 from the suction basin 2. The horizontal pipe 36 forms a water duct 86 distanced to a greater or lesser extent from the water duct 85 associated with the obstructing device 17. It may be preferred to have a backup tunnel 31 which does not traverse the reserve basin 20. Furthermore, as explained above with reference to FIG. 24, the obstructing device 17 may be associated with a trigger device 70 comprising, for example, a winch acting on a cable 71. The trigger device 70 is connected here to a control system 50 associated with multiple water level detection systems using water sensors 28 to detect primarily whether the water level in the suction basin 2 has dropped in a manner defined beforehand as abnormal, the measurement of the rate of change of the water level possibly being a parameter for determining an abnormal drop.

In order to close off the water duct 86 formed by the backup tunnel 31, an autonomous closing device such as one or the other of the obstructing devices 9 and 16 described above with reference to FIG. 17 and FIG. 19 may be used, as this is the same configuration of a closed suction basin that one must be able to place in communication with the sea via a backup tunnel. With such an obstructing device 9 or 16, the opening of the device will be arranged to trigger for a level L₂ higher than the predetermined level L_{2V} for triggering the opening of the closing device 17 which blocks the water duct 85 between the suction basin and the reserve basin, so that practically none of the water in the reserve basin is used except when there is an abnormal withdrawal of the sea.

An autonomous obstructing device such as device 9 or 16 is not essential, however, and in particular it is conceivable to use an obstructing device 19 which is only opened by a trigger device. The lack of autonomy of such an obstructing device 19 does not necessarily compromise the safety of the installation, and in particular there can be redundancy in the trigger device assigned to the obstructing device. In addition, the obstructing device 19 in the installation of FIG. 25 is preferably designed to open only when a critical collapse in the suction tunnel or tunnels 3 has occurred, and is intended to open before the water level L₂ in the suction basin reaches the predetermined level L_{2 V} for triggering the opening of the obstructing device 17. As a result, if there is a malfunction in opening obstructing device 19, the water level L₂ in the suction basin continues to drop to the predetermined level L_{2V}, which triggers the opening of obstructing device 17 automatically or by the associated trigger device 70, thus supplying the suction basin from the reserve basin. The volume of water in the reserve basin 20 is usually enough to supply the pumps for backup operation for at least two hours, which provides time to restore control to the opening of obstructing device 19.

To ensure that obstructing device 19 is only opened in cases of critical collapse in the suction tunnel or tunnels 3, we need to be able to determine with certainty that a rapid drop in the water level L₂ of the suction basin is not due to a withdrawal of the sea. To achieve this, the control system 50 may be associated not only with a system for detecting a decrease in the suction tank water level, but also a system for detecting a decrease in the level of the sea. Each detection system, comprising for example water sensors 28 at different heights for measuring the water level, sends data 29 to an analysis system associated with the control system 50. The analysis system is intended to determine if the water level in the suction tank 2 is dropping in a manner defined beforehand as abnormal and if the level of the sea has not dropped abnormally. If both conditions are true, it is almost certain that the suction tunnel or tunnels have suffered a critical collapse. The control system 50 then sends a trigger command 59 to a trigger device 70 to actuate opening obstructing device 19, for example by pulling a cable 71 to unlock a locking system that keeps obstructing device 19 closed. The trigger command 59 may also initiate switching from the production pumps of the pumping station to the backup pumps. As represented in FIG. 25, once the obstructing device 19 is open, the backup tunnel 31 supplies water to the suction basin 2 and the water level L₂ rises to stabilize at more or less the level L₁ of the sea. One will note that the water duct 86 formed by the backup tunnel 31 may be lower than the representation shown in FIG. 25, and may for example be located at the bottom of the reserve basin in the same manner as water duct 85.

FIG. 26, as well as FIG. 27, FIG. 28, and FIG. 29, represent different positions of a same obstructing device 19 and are discussed together. The obstructing device 19 shown is an example embodiment of a non-autonomous closing device which can be used in the water supply system of the water intake installation of FIG. 25. In FIG. 26 and FIG. 28, the obstructing device 19 is represented in its closed position. The device comprises an obstructing member 90 in the form of a generally planar sealing panel that is pivotable about a pivot shaft 91. The panel 90 closes off the water duct 86 formed in a face of the dam wall 80. The closed position is maintained by a locking system comprising brackets 82 attached to the wall 80 and a locking bar 72 inserted between the brackets 82 and a free end portion of the panel 90. The locking bar 72 is connected to at least one cable 71 which can be pulled by a trigger device 70 as described above. Rollers 73 may be provided on either side of the locking bar 72 to facilitate displacement of the bar when unlocking the device.

As represented in FIG. 27 and FIG. 29, actuation of a cable 71 pulls the locking bar 72 upward so that it no longer prevents the sealing panel 90 from pivoting under the effect of the differential water pressure applied on the face of the panel on the reserve basin 20 side. The panel 90 is designed to pivot at least 90° in order to completely unobstruct the water duct 86 formed by the backup tunnel. As represented in FIG. 30, it may be arranged that the pivot shaft 91 of the sealing panel 90 is formed by a bar 99 having a ridge along its length, for example a ridge having an oval profile, the bar 99 pressing against a concave surface of a mounting member 81 parallel to the bar 99 and fixed to the wall 80. The contours of said ridge of the bar 99 and of the concave surface of the mounting member 81 are shaped to allow the panel to pivot at least 90° without excessive jamming or friction.

In FIG. 31, another embodiment of a water intake installation similar to that of FIG. 20 exclusively uses non-autonomous obstructing devices 19, meaning devices which are only opened by a trigger device. The control system 50 is adapted to control the opening of each obstructing device 19 individually, and is associated with systems for detecting a water level decrease in the suction basin 2 and in the reserve basin 20 using sensors 28 that detect the presence of water. An obstructing device 19 may open irreversibly, meaning as was the case for the device 19 described above that it is not possible to close the obstructing member 90 without performing a specific operation once open. It is also possible for an obstructing device 19 to open reversibly, as is the case for example for a butterfly valve or a gate valve.

If there is an abnormal drop in the water level L₂ in the suction basin, the first obstructing device 19, located between the suction basin 2 and the reserve basin 20, is triggered open while the second obstructing device 19 which blocks the backup tunnel 30 remains closed. The trigger command 59 also causes a switch from the production pumps of the pumping station to the backup pumps. The cross-sectional area of the water duct opened by the first obstructing device 19 is intended to be small enough that the water level L₃ in the reserve basin 20 does not drop too quickly, but must allow sufficient flow, for example between 5 m3 and 15 m3 per second, so that while the production pumps are shut down the water level L₂ in the suction basin 2 remains only slightly below the mouth E7 of a passage 7 connecting the suction basin to the suction tunnel 3. The volume of water in the storage basin 20 is intended to be enough so that, if the abnormal drop in level L₂ is due to a withdrawal of the sea, the supply of water to the backup pumps is ensured until the sea returns to above its lowest tide level L_{L}, and the water level in the reserve basin 20 remains above the level L₄ that triggers the second obstructing device 19. The reserve basin 20 is covered by a cover device 25′ provided with at least one calibrated opening 27, in particular in the case of an obstructing device 19 that opens non-reversibly, to prevent the reserve basin from overflowing and flooding the plant in case of a tsunami.

If the abnormal drop in level L₂ is due to a critical collapse in the suction tunnel or tunnels 3, the water level in the reserve basin 20 falls relatively slowly until it reaches the level L₄ that triggers the second obstructing device 19, and the system for detecting a dropping water level in the reserve basin 20 issues a trigger command 59 to open the second obstructing device. As a precaution, it is possible to order the second obstructing device to open before level L₄ is reached, once it is certain that there has been a critical collapse in a tunnel 3. The reserve basin is then supplied with water by the backup tunnel 30. The water level L₂ in the suction basin 2 and the water level L₃ in the reserve basin 20 climb back up to substantially the level L₁ of the sea. The operation of the pumping station of the nuclear power plant in safe mode is thus ensured, even in the case of another tsunami event.

As an alternative to the above embodiment, it is also possible to connect the backup tunnel 30 to the suction basin 2 directly. The opening of the second obstructing device 19 associated with the backup tunnel 30 would then be ordered once it is certain that the suction tunnel or tunnels 3 are more or less blocked. In addition, a non-autonomous obstructing device such as the obstructing device 19 described above with reference to FIGS. 26-30 may be used in place of an autonomous obstructing device in a water supply system with no reserve basin, for example the water supply system described above in reference to FIG. 17, instead of the valve device 9. In this case, if the obstructing device 19 must be opened at some point, the device must be returned to the closed position before the production pumps are restarted once the suction tunnel or tunnels 3 are operational, to avoid the water coming from a suction tunnel being heated by the water coming from a backup tunnel 30.

A water intake installation according to the invention can be intended for equipping a nuclear power plant separated from the sea by land unsuitable for construction or by a wide strip of dunes or other irregularities that descend in the inland direction, to mean sea level or below. It is understood that a suction basin of the installation must be shaped so that the basin floor is below mean sea level and at least several meters below the lowest tides for bodies of water having tides. Depending on the suitability for construction and/or the topology of the land along the coast, it is possible to construct the nuclear power plant at a site some distance from the shore, for example up to about five kilometers away, taking into consideration the increased construction costs of a suction tunnel for an installation with a tunnel of such length.

If the coastline may experience exceptional tidal waves such as tsunamis, a nuclear power plant having a water intake installation such as one of the installations described above with reference to FIGS. 17 to 31 can be installed away from the shoreline, lengthening each suction tunnel and each backup tunnel accordingly. In other cases, where there is no such risk of tidal waves, a water intake installation as described above with reference to FIG. 17 but without the cover device for the suction basin may be used.

For reasons concerning the construction costs and maintenance of the water intake installation, or for safety reasons in areas of seismic activity, it may be advantageous to dispense with a backup tunnel for such a plant established at a distance from the shoreline, as long as there is an auxiliary source of water such as a river or lake for example. In such cases, an emergency water reserve may be provided, comprising a reserve basin which can supply water to the suction basin of the installation by a system for supplying additional water as described above.

As represented in FIG. 32, such an embodiment of a water intake installation according to the invention, intended for a nuclear power plant separated from the shoreline by a strip of land Z unsuitable for construction, comprises a reserve basin 20 which can be placed in communication with the suction basin 2 via a water duct 86 formed in a wall 80 separating the two basins. The water duct 86 here is closed off by a non-autonomous obstructing device 19, controlled by a control system 50 associated with a system for detecting a decrease in the suction basin water level. Alternatively, an autonomous obstructing device may be used such as one of the passively activated obstructing devices 9, 16, 17, and 18 described above. Regardless of the type of obstructing device, the device must open when there is an abnormal drop in the water level L₂ in the suction basin, and at the latest when the water level L₂ has dropped below the lowest tide level L_{2L} down to the predetermined trigger level L_{2V}.

In the embodiment represented, water sensors 28 measure the rate of change of the water level. If the level is dropping at a rate exceeding a predetermined threshold greater than the highest known normal rate of change in the tide level, this event is characteristic of an abnormal condition indicating either an obstruction or blocking of the suction tunnel or tunnels 3 or an abnormal withdrawal of the sea. Once the abnormal condition is detected, the control system 50 sends a trigger command 59 to a trigger device, not shown in the figure, to actuate the opening of the obstructing device 19. The control system 50 also controls the shutdown of electricity production by the reactor unit or units associated with the suction basin 2, and the switch from the normal production pumps of the pumping station 10 to the backup pumps.

In a situation of normal production of electricity by the plant as represented in FIG. 32, the obstructing device 19 closes off the water duct 86 and thus prevents the water in the suction basin from being heated by the water in the reserve basin when the latter is warmer, especially in summer. The water level L₃ in the storage basin 20 is kept relatively constant and close to completely filling the basin, for example at a height exceeding the highest tide level L_{H}, so that in case of heavy rainfall the surplus water in the reserve basin overflows to the suction basin 2 where the level L₂ is lower. The volume of water in the reserve basin is intended to be sufficient to supply the backup pumps for a predetermined emergency period after the production pumps have been shut down, for example at least four hours.

During the predefined emergency period, and according to a set procedure, arrangements are quickly made to supply water to the reserve basin, or to the suction basin directly, by an auxiliary water source such as a river 5′. The average flow of water that can be drawn from the auxiliary source must be greater than or equal to the pumping rate of the backup pumps. For example, taking enough water to ensure an average flow rate of at least 5 m3 per second of water is usually sufficient in most nuclear power plants to meet the needs of a pumping station of a reactor unit which has stopped producing electricity.

The water can be drawn from the river 5′ for example using an auxiliary pumping station 10′ located at the edge of the reserve basin 20 and connected to the river 5′ by underground piping. The pumps of the auxiliary pumping station 10 are advantageously started up shortly after the obstructing device 19 is opened, in order to maintain in the reserve basin 20 a level L₃ that is close to the fill level of the basin. In this manner, even if a long term problem arises with drawing water from the river 5′, for example a failure in the auxiliary pumping station 10′, the plant personnel has a period of several hours to take appropriate measures to restore an adequate water supply for the backup pumps.

1. A water intake installation for at least one heat exchanger-based cooling circuit of a nuclear power plant, comprising:
a suction basin from which at least one pumping station of the plant draws water in order to circulate it within one said cooling circuit; and
at least one suction tunnel connected to at least one main water intake submerged in a body of water, said suction tunnel supplying the suction basin with water so as to maintain a water level in the suction basin that is sufficient for the operation of said at least one pumping station;
wherein the water intake installation further comprises a system for supplying additional water distinct from said at least one suction tunnel and capable of supplying water to the suction basin from at least one emergency water reserve, said system for supplying additional water comprising at least one water duct connecting the suction basin to said emergency water reserve and an obstructing device closing off said water duct, the obstructing device being able to open said water duct at least partially if the water level in the suction basin drops in a manner defined beforehand as abnormal, so that the suction basin is supplied with water by said system for supplying additional water if the water supplied by said at least one suction tunnel becomes insufficient.

2. The water intake installation according to claim 1, wherein said body of water constitutes one said emergency water reserve.

3. The water intake installation according to claim 2, wherein said body of water is a sea, and said system for supplying additional water is arranged between the suction basin and a portion of a channel which communicates with the sea.

4. The water intake installation according to claim 2, wherein said system for supplying additional water comprises a backup tunnel connected to at least one backup water intake submerged in said body of water, said backup water intake being placed at a height at least ten meters above one said main water intake.

5. The water intake installation according to claim 1, wherein one said at least one emergency water reserve comprises a reserve basin containing a volume of water which remains substantially unchanged when water is being supplied normally to the suction basin by said at least one suction tunnel.

6. The water intake installation according to claim 1, wherein said at least one main water intake is placed at a certain depth relative to a mean reference level of said body of water, said depth being determined such that the water flowing into the suction basin has, during at least one period of the year, a maximum temperature at least 4° C. lower than the maximum temperature of the water at the surface of said body of water.

7. The water intake installation according to claim 1, wherein said obstructing device comprises an obstructing member able to pivot about a pivot shaft in order to open said water duct.

8. Water The water intake installation according to claim 7, wherein said obstructing device is adapted so that the pivoting of said obstructing member occurs autonomously according to a drop in the water level in the suction basin.

9. The water intake installation according to claim 7, wherein the pivoting of said obstructing member is actuated by a trigger device connected to a control system able to generate a trigger command for the trigger device, the control system being associated with an analysis system receiving data provided by a device for measuring the water level in the suction basin, said analysis system being able to determine whether the water level in the suction basin is dropping in a manner defined beforehand as abnormal.

10. The water intake installation according to claim 9, wherein said obstructing device is adapted so that the pivoting of said obstructing member occurs autonomously according to a drop in the water lever in the suction basin and wherein said trigger device is adapted to allow the pivoting of said obstructing member to be performed autonomously by said obstructing device if the trigger device does not perform its function.

11. The water intake installation according to claim 8, wherein said obstructing member pivots to open said water duct when a height difference between the water level in the emergency water reserve and the water level in the suction basin exceeds a predetermined threshold.

12. The water intake installation according to claim 8, wherein said obstructing device comprises a counterweight means arranged on a side opposite the obstructing member relative to said pivot shaft, said counterweight means comprising a main counterweight member located at a fixed distanced from said pivot shaft, and said main counterweight member weighing between 80% and 200% of the weight of said obstructing member.

13. The water intake installation according to claim 8, wherein said obstructing member comprises a float device arranged so that it is fully submerged in water when water is being supplied normally by said at least one suction tunnel and so that it is at least partially exposed if the water level in the suction basin falls below a predetermined level of lowest tide to reach a predetermined trigger level, said float device being adapted to cause said obstructing member to pivot when said trigger level is reached.

14. A nuclear power plant comprising the water intake installation according to claim 1, wherein the suction basin is covered by a device forming a substantially watertight cover, and at least one calibrated opening is made in the cover device or nearby to allow a limited flow of water to outside the suction basin if the suction basin overflows due to an unusual rise in said body of water, the nuclear power plant further comprising at least one discharge shaft feeding water to an outflow tunnel, said discharge shaft also being provided with a cover device having at least one calibrated opening to allow a limited flow of water to the outside in case of overflow of the discharge shaft.

15. The nuclear power plant according to claim 14, wherein one said emergency water reserve comprises a reserve basin having its top open to the outside and containing a volume of water that remains substantially unchanged when water is being supplied normally to the suction basin by said at least one suction tunnel, and wherein said at least one calibrated opening leads to said reserve basin to allow collecting said limited flow of water therein.
